(19) United States
(12) Patent Application Publication
(10) Pub. No.: US 2021/0064141 A1
(43) Pub. Date: Mar. 4, 2021

(54) SYSTEM FOR DETECTING A SIGNAL BODY GESTURE AND METHOD FOR TRAINING THE SYSTEM

(71) Applicant: SoleCall Kft., Budapest (HU)

(72) Inventors: Géza Németh, Budapest (HU); Bálint Pál Gyires-Tóth, Budapest (HU); Bálint Czeba, Domony (HU); Gergö Attila Nagy, Budapest (HU)

(21) Appl. No.: 16/643,976

(22) PCT Filed: Sep. 3, 2018
(86) PCT No.: PCT/HU2018/000039

§ 371 Date: Mar. 3, 2020

(30) Foreign Application Priority Data
Sep. 4, 2017 (HU) P1700368

(51) Int. Cl. G06F 3/01; G06K 9/00; G06K 9/62; G06N 3/08; H04M 1/725

(52) U.S. Cl. CPC G06F 3/017; G06K 9/00335; G06K 9/627; H04M 2250/12; H04M 1/72541; H04M 1/72563; G06N 3/08

(57) ABSTRACT

The invention is a system for detecting a signal body gesture, comprising a mobile device and a kinetic sensor adapted for recording a measurement motion parameter pattern corresponding to the time dependence of a motion parameter of the mobile device in a measurement time window, and a decision unit applying a machine learning classification algorithm subjected to basic training utilizing machine training with the application of a training database comprising signal training motion parameter patterns corresponding to the signal body gesture, operated in case the measurement motion parameter pattern having a value equal to or exceeding a predetermined signal threshold value, suitable for classifying the measurement motion parameter pattern to a signal body gesture category. The invention is, furthermore, a method for training the system.

### TECHNICAL FIELD

The invention relates to a system for detecting a signal body gesture and a method for training the system, wherein the signal body gesture is by way of example a foot stamp or a knock (even performed through a cloth or a bag). The invention further relates to a method for detecting a signal body gesture, a method for issuing a signal, particularly an alarm signal, a mobile device application controlled by the signal issued by the method, a control method utilizing the signal, and to a data recording method.

### BACKGROUND ART

With the widespread use of so-called smart devices, there is an increasing demand for devices that behave in a “smart way” in certain situations. Emergency situations are an important field in this respect. In emergency situations people need outside help, and in many cases they are unable to call for it—either as a result of an attack or a trauma—in a conventional way, i.e. to give an emergency signal by making a phone call.

Accordingly, systems adapted for assisting people in such situations are available.

In DE 10 2007 024 177 A1 a system adapted for making an emergency signal applying a mobile device is disclosed. The system has settings for acceleration limits for detecting an emergency signal, issuing an alarm if the acceleration measured by the accelerometer exceeds the limits. According to this approach the accelerometer is arranged separately from the mobile device (it is implemented as an external device with respect to the mobile device), and the external device detects and classifies the encountered situations based on the pre-set acceleration limits. In case of emergency a notice is sent over a wireless connection to the user's mobile device by the external device that reacts to the notice by sending a message or making a phone call.

In the system disclosed in US 2012/0225635 A1 the user may request assistance for example by shaking the device. By comparing the sum of the absolute value of the resulting accelerations to a threshold value, the system makes a rule-based decision on whether an alarm is detected or not.

Likewise, in US 2014/0349603 A1, exceeding a predetermined value is required for raising an emergency signal. In this approach, the shaking event that is exemplarily associated with the emergency signal is detected applying a gyroscope sensor.

In the approach disclosed in US 2015/0229752 A1 the mobile device has to be taken out from its storage place for issuing the emergency signal. According to this approach, issuing the emergency signal can be based on recognizing a number of different gestures; this approach also involves setting threshold values for deciding whether an emergency signal has been made.

In WO 2016/046614 A1 an approach for calling help without attracting an attacker's attention is disclosed. This approach is based on a wearable device comprising at least one accelerometer. The wearable device is capable of communicating over a wireless connection and transmitting the emergency request to the user's mobile device. The sensor adapted for motion detection has to be arranged in the wearable device, while the data related to the motion can be processed either there or in the mobile device.

A personal alarm device system based on a mobile device is disclosed in US 2016/071399 A1.

A method and device for gesture recognition is disclosed in CN 106598232 A. In EP 3,104,253 A1 an insole for detecting a foot gesture input signal is disclosed; the disadvantage of this approach is that it requires a specially configured complex device (the insole) and its wearing for detecting the signal.

In EP 3,065,043 A1 signal recording by means of an acoustic sensor and signal evaluation based on signal peak detection is disclosed.

A common drawback of most of the above referenced alarm methods and systems is that a decision on detecting an alarm is made exclusively in a rule-based manner. In most cases, the rules are specified for acceleration values, which or quantities derived therefrom are compared with a threshold value. As it is apparent from the above cited disclosures, for providing a well-founded rule-based decision, certain approaches apply rather complex rule systems. In a number of known approaches, furthermore, the mobile device (which is also in many cases the detecting device as well) has to be taken out of its storage place in order to activate the emergency signal.

The problems associated with exclusively rule-based decision making applied in the above mentioned known approaches for detecting the event of issuing a signal—such as an emergency signal—are illustrated by the disclosures presenting the approaches, and especially by the fact that in certain approaches the mobile device has to be taken out in order to issue the alarm signal. A disadvantage associated with many known approaches is therefore that the mobile device has to be taken out for issuing the emergency signal. In many situations, this requirement may prevent the user from issuing an emergency signal.

In view of the known approaches, there is a demand for a system and method for sensing or detecting a signal body gesture, i.e. for example alarm gesture, that is applicable in a more effective manner than the known approaches, and that allows for reducing the number of false alarms preferably to a level below that provided by known approaches.

### DESCRIPTION OF THE INVENTION

The primary object of the invention is to provide a system for detecting signal body gestures (body gestures for signaling) and a method for training the system, which are free of disadvantages of prior art approaches to the greatest possible extent.

A further object of the invention is to provide a system for detecting signal body gestures and a method for training the system that implement their features in a more efficient way compared to known approaches.

The objects of the invention can be achieved by the system for detecting signal body gestures according to claim 1, the method for training the system according to claim 12, the method for detecting signal body gestures according to claim 22, the method for issuing a signal according to claim 23, the mobile device application according to claim 24, the method for controlling the mobile device application according to claim 25, and the method for data recording according to claim 26. Preferred embodiments of the invention are defined in the dependent claims.

According to the invention, it has been recognized that a combination of machine learning classification algorithms and rule-based decision-making can be applied for recognizing emergency signals or any other intentional signal (signal body gesture) with outstanding effectiveness.

It is of utmost importance in respect of the invention that the decision unit applying a machine learning algorithm is capable of analysing and evaluating the progress of the signal body gesture over an entire time window—that is chosen to be wider than the expected signal length of the signal body gesture—directly (it should be fed to its input directly), instead of feeding to its inputs only partial data selected from the signal or a signal extract generated based on some aspect (e.g. a signal obtained by omitting “empty” sections with low amplitude values, i.e. sections containing no relevant signal). This feature is required in order to exploit the advantages of the machine algorithm, because in this manner the features and characteristics of the signal detected in the course of the training process can be utilized more effectively by the machine learning algorithm.

It has been recognized that the efficiency of the above described known approaches choosing one of the ways (i.e. either rule-based decision or a decision unit applying a machine learning classification algorithm) is limited, but the efficiency can be highly improved if a combination of these ways is applied.

Such a combination is not disclosed in the documents referenced above. This combination is particularly preferable for separating the signal body gesture from other movements (walking, running, other everyday activities; see the “other” category above). According to the invention, therefore, a decision can be made with high confidence also in the case of user signal body gestures that cause complex, not easily separable signal shapes.

As it is also illustrated by the above referenced known approaches, systems for detecting emergency signals can be implemented even based on very complex rule sets. However, if these systems do not receive assistance from a decision unit based on a machine learning classification algorithm, in certain situations they will make false decisions. False decisions may also be the result in some cases if some kind of decision-assisting rule is not applied together with the decision unit based on a machine learning classification algorithm. As an example for this it can be mentioned that in case training is performed with a training database having a case number under a certain limit it may happen that the decision unit based on a machine learning classification algorithm will be more sensitive to signal shape than signal magnitude. As a result of this, it could falsely assess a very low-amplitude signal as being an intentional signal, if a desired signal level threshold is not specified in a rule (see below in more detail).

The system according to the invention can be applied for initiating by way of example an emergency alarm, an emergency call or a help request applying a signal body gesture, i.e. a body signal, gesture or even a sudden bodily reaction (an unintentional movement made under an external impact).

The signal body gesture is preferably constituted by movements of a predetermined number, direction and intensity performed by the body or body part (e.g. head, hand, foot, or other body part suited for signaling) of the user (that preferably has as intense an action on the mobile device as possible via the body or clothes, for example causing the mobile device to accelerate), e.g. a foot stamp (even multiple foot stamps), but it can also be a vibration/bodily reaction caused by hitting hard (making a knock, or multiple knock, on the mobile device even through the clothes) on the body (the mobile device is displaced to a certain extent also in this latter case, which can be detected in the signal shape of the kinetic sensor). The signal body gesture can be constituted by a number of further movements or gestures, such as shaking a leg/foot in a given direction (this is also a movement that may seem unintentional under severe stress), or a “sweep” gesture performed by the sole of the foot touching the ground.

Furthermore, according to the invention human-machine interaction can be made more intuitive based on the recognized behaviour patterns, by way of example because the device can either automatically execute the steps required by a particular context, or makes suggestions to the user to execute them so that the user does not need to manually perform these steps. Accordingly, the system according to the invention can also be applied for controlling a mobile application.

According to the invention, substantially an application package is provided by the system that is capable of recognizing user activities and certain predetermined motion patterns with high accuracy, and, based on that, of controlling certain functions (such as issuing an alarm, or controlling a mobile application, based on recognizing the signal body gesture) of the mobile device (smartphone). In the present case this amounts to a safety alarm initiated by a foot stamp. Gestures are preferably recognized by the system applying models based on deep neural networks (DNN; see in more detail in: Y. LeCun, Y. Bengio és G. Hinton, “Deep learning,” Nature 521.7553, pp. 436-444, 2015) providing high accuracy and flexibility.

It has been therefore recognized according to the invention that the technical approaches constituting the prior art can only be applied under very restricted circumstances. Thus, utilizing prior art devices a user has no chance to issue an emergency signal in many emergency situations. This is, however, allowed for by the invention; according to the invention it is possible that the signal body gesture corresponds to an almost reflex-like movement (such as a foot stamp), so the user is never blocked from performing it.

Upon recognizing the signal body gesture in case of an attack, the system according to the invention may therefore preferably automatically issue an emergency alarm signal/message to the to be alarmed community service/a body authorized to respond to such a situation (police, civil guards) and/or to other designated persons. The alerted central system (the operator answering the call) may check the validity of the alarm by calling back the user/asking for confirmation via the user interface, and, based on the GPS coordinates of the device issuing the alarm that were preferably sent together with the alarm message, can direct the helpers to the location given by the GPS coordinates. The emergency signal arriving to the central system may comprise, in addition to the GPS coordinates of the mobile device, the time at which the signal was issued, and the identifier of the user that had expediently been assigned to the user at the time of registration. The alarm message sent to community service/a body authorized to respond to such a situation after the confirmation may comprise the basic personal data of the user: sex, age, description of outward appearance.

### BRIEF DESCRIPTION OF THE DRAWINGS

Preferred embodiments of the invention are described below by way of example with reference to the following drawings, where

FIG. 1A is a schematic drawing illustrating a possible arrangement of the mobile device of the system according to the invention and a foot stamp as a signal body gesture,

FIG. 1B is a schematic drawing illustrating a further possible arrangement of the mobile device of the system according to the invention and also illustrates a foot stamp applied as a signal body gesture,

FIG. 2A shows acceleration as a function of time, the part of the function that falls in a given time window providing an exemplary motion parameter pattern,

FIG. 2B illustrates the function shown in the previous figure over a more restricted time period,

FIG. 3A shows an orientation-time function recorded simultaneously with the function above, with the part of the function falling in a given time window providing a further exemplary motion parameter pattern,

FIG. 3B illustrates the function shown in the previous figure over a more restricted period,

FIG. 4 illustrates a possible choice of coordinate system on an exemplary mobile device,

FIG. 5 is a block diagram illustrating an embodiment of the system according to the invention,

FIG. 6 is a diagram illustrating a further embodiment of the system according to the invention,

FIG. 7 schematically illustrates the structure of the deep learning model applied in an embodiment of the invention,

FIG. 8 illustrates the data format expediently fed to the input of the machine learning classification algorithm in an embodiment of the invention,

FIG. 9 is a block diagram of an embodiment of the system according to the invention,

FIG. 10 is a block diagram illustrating an embodiment of the mobile device applied in the system according to the invention,

FIG. 11 illustrates an exemplary elementary neuron, and

FIG. 12 illustrates an exemplary feed-forward neural network.

### MODES FOR CARRYING OUT THE INVENTION

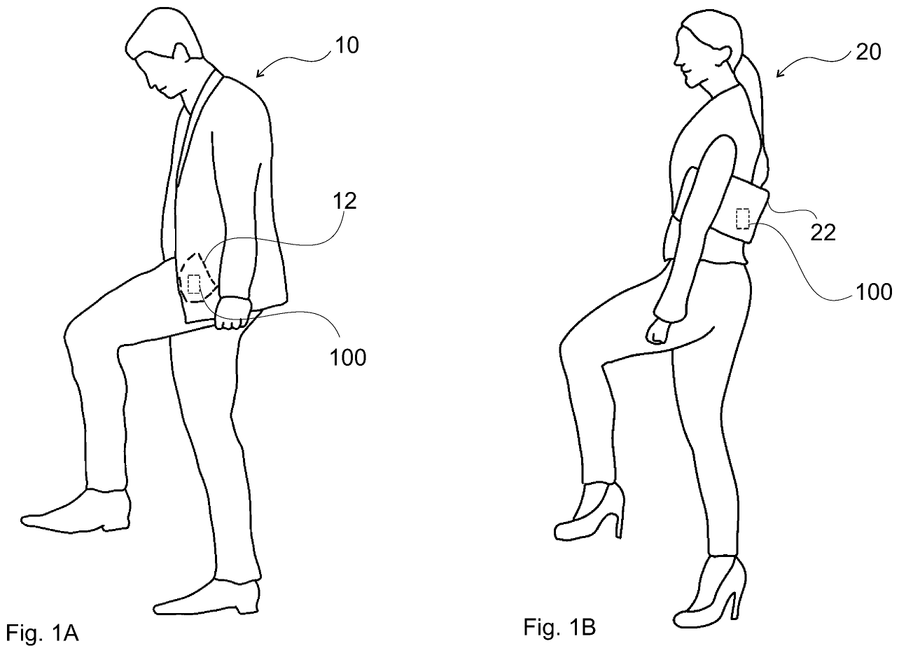

FIGS. 1A and 1B illustrate two different arrangement/wearing configurations of the mobile device 100 comprised in the system according to the invention. The illustrated carrying modes are widespread among users; it is also widespread that the mobile device is put into a trouser pocket (from the aspect of the system according to the invention it does not make any difference whether the device is in a front or a rear pocket).

In FIG. 1A a male user 10 is illustrated, with his mobile device 100 put in the inside pocket of his suit jacket (outerwear). In case of such a wearing/carrying configuration the mobile device 100 can move relatively freely relative to the user 10 together with the part of the outerwear comprising the pocket, making a much looser contact between the user 10 and the mobile device 100 compared for example to the case where the mobile device 100 is put in a trouser pocket. Such outerwear (suits) typically have a loose fit, with their flaps (either interconnected or not at the front) typically hanging somewhat loose from the body, especially during walking.

In the situation illustrated in FIG. 1B, the mobile device 100 of the user 20 is placed in a bag 22. This is another widespread carrying configuration, often applied with the intention to keep the mobile device 100 as far as possible from the user's body. As with the wearing/carrying configuration involving the mobile device 100 being put in a pocket 12 according to FIG. 1A, placing it in a bag 22 also results in a more loose connection between the device and the body of the user 20.

As it is discussed below in detail, in the system according to the invention, this somewhat looser connection does not pose any problem for detecting a signal body gesture (e.g. a foot stamp or knock). Thanks to the application of the machine learning classification algorithm, signal body gestures can be detected for a mobile device being in a close connection with the user's body, but also with a mobile device that is more loosely connected thereto. The machine learning classification algorithm can also be called a machine classification or categorization algorithm or a machine learning algorithm suitable for classification. Accordingly, a signal can be issued by performing any such signal body gesture (body gesture for signaling) that the machine learning classification algorithm has been trained for, i.e. intentional signaling is possible.

The system according to the invention is adapted for detecting (observing, revealing) a signal body gesture. The system according to the invention comprises a mobile device and a kinetic sensor adapted for recording a measurement motion parameter pattern (motion parameter pattern obtained by measurement) corresponding to a motion parameter (motion characteristic, motion data) of the mobile device in a measurement time window. The motion parameter may be various such quantity that describe the characteristics of the motion. Preferably, the selected motion parameter may be acceleration, or one or more components thereof (i.e. projections thereof on given coordinate axes). The motion parameter pattern is a portion of the motion parameter-time function that falls into a measurement time window, i.e. the term “pattern” is taken to refer to a section of the function.

The kinetic sensor applied in the system according to the invention is adapted for recording the value of the motion parameter. In case the motion parameter is acceleration, the kinetic sensor is expediently an accelerometer; however, acceleration can also be measured in another manner, utilizing a different device. The motion parameter may also be a parameter other than acceleration; besides that, more than one different parameters may also be applied (e.g. acceleration and orientation) as motion parameter, in which case the kinetic sensor comprises sensors adapted for measuring acceleration and orientation (e.g. a pitch sensor). In this case, the term “kinetic sensor” is taken to refer to a plurality of sensors.

The system according to the invention further comprises a decision unit (decision module) applying a machine learning classification algorithm subjected to basic training (i.e. it is trained) by means of machine learning with the application of a training database comprising signal training motion parameter patterns (training motion parameter patterns corresponding to the signal) corresponding to the signal body gesture, operated in case the measurement motion parameter pattern having a value being equal to or exceeding a predetermined signal threshold value, and being suitable for classifying (categorizing) the measurement motion parameter pattern to a signal body gesture category.

The decision unit may also be called a machine decision unit, or alternatively, an evaluation or categorization unit. The decision unit is therefore essentially utilized for deciding whether a given measurement motion parameter pattern can be classified into a signal body gesture category (class), i.e. whether the measured pattern (signal) corresponds to a signal body gesture. Thus, the decision unit is suitable for classifying (or, alternatively, for rejecting). Furthermore, the machine learning classification algorithm may also be called a machine recognition algorithm (recognition implying that the measured signal can be classified into the given category or not). Basic training is basically a person-independent, generic training process.

According to the above, the training database comprises signal training motion parameter patterns; these patterns correspond to the signal body gesture, i.e. are positive training samples; in addition to that—in order to teach the system what does not constitute a signal—such databases typically also comprise training motion parameter patterns that do not correspond to a signal body gesture, but e.g. to walking, i.e. they do not correspond to the signal.

The decision unit is therefore operated only in case the value of the measurement motion parameter pattern (i.e. a value of the motion parameter of the motion parameter-time function inside the time window corresponding to the motion pattern) is equal to or exceeds a predetermined signal threshold value. On the one hand, therefore, decisions are made by the system in a rule-based manner, and on the other hand the decision unit is based on machine learning classification algorithms, i.e. a combination of rule-based and machine learning-based decision making is implemented.

Some embodiments of the invention relate to a method for training the system according to the invention. Training is aimed at the system, more particularly the decision unit and the machine learning classification algorithm thereof. In the course of the method according to the invention the machine learning classification algorithm of the decision unit is subjected to basic training by means of machine learning with the application of a training database comprising signal training motion parameter patterns corresponding to the signal body gestures. Certain aspects and features of the system and the method according to the invention are common, i.e. preferably all such features that can be applied for the system (or are introduced related to it) can also be applied for the method, and vice versa. By that is meant that the system can be trained applying any embodiment of the method according to the invention adapted for training the system, and furthermore, any embodiment of the system can be subjected to the training method according to the invention (in an embodiment the machine learning classification algorithm of the decision unit is subjected to basic training applying an embodiment of the method according to the invention).

The signal body gesture is provided by moving a part of the body, it is intended to give a signal with this moving. The signal body gesture is by way of example a foot stamp (stamping with a foot); this choice can be advantageous because the stress caused by an emergency situation can induce an instinctive boost for making such a gesture, i.e. in an emergency situation it comes natural to a user that an alarm can be activated/issued by a foot stamp in an embodiment of the system according to the invention.

In an embodiment the signal body gesture may be an indirect knock (tap) on the mobile device. It is also conceivable that the decision unit may also be trained for stamping and for indirect knock, so any one of these can be applied as a signal body gesture, i.e. the signal body gesture can be (at least one) stamp with the foot and an indirect knock on the mobile device. An “indirect knock on the mobile device” is taken to refer to such—typically multiple—knock (hit)-like movements that are indirectly aimed at the mobile device. By being “indirectly aimed at” the device it is meant that the gesture is performed through the clothes or a bag on a mobile device that is placed in a pocked or in the bag. The knock can be severely indirect, when a knock is performed on the clothes somewhere near the mobile device, or nearly direct, when the body part performing the knock (typically, a hand) is separated from the mobile device only by a thin layer of textile. According to the above, the signal body gesture can also be termed otherwise, e.g. a signaling (signal giving) body gesture or even a signaling (body) movement.

The emergency signal issued by the system is transmitted to an alarm detecting device that—detecting the signal received from the signal source, i.e. the emergency signal—evaluates and transmits it to the central system which alerts the community service/a body authorized to respond to such a situation (e.g. police, civil guards) and/or other designated persons (a relative, a friend, an acquainted person).

The system is capable of more than just issuing an alarm signal. The decision unit of the system is trained for a signal body gesture that can essentially be an activation (trigger) signal applied either for launching (starting) an application on the mobile device or a remote application over a wireless connection.

The kinetic sensor may also be called a movement sensor or motion sensor. For example, the kinetic sensor may be an accelerometer or a position sensor adapted for recording the values of the trajectory or position vector as a function of time, from which the acceleration-time function can be obtained.

According to the above, a distinction is made between training and measurement motion parameter patterns (and, as it is shown below, a personalizing motion parameter pattern). The main difference between these is that the measurement motion parameter pattern is actually measured data recorded from the real motion of a user. In contrast to that, the training motion parameter pattern is a piece of training data that forms a part of the training database. Training data may come from different sources: it can be labeled measurement data (i.e. measurement results that are known to (or not to) correspond to the signal body gesture), or even artificially generated data series. Preferably these can be easily recognizable data series or data series that are difficult to recognize and are therefore expedient to learn for pattern recognition. Data augmentation can also be applied, but this is typically also based on real recorded data. Rotations of different types can e.g. be applied to the data in order to model, by way of example, situations involving the user putting the phone (mobile device) in their pocket/bag in different ways.

The database comprises labeled data, i.e. it is known about the training motion parameter patterns corresponding to the signal body gesture that these really correspond to the given signal body gesture, and in addition to that—also labeled in an appropriate manner—the database preferably also comprises pattern data series that do not correspond to the signal body gesture. Such data series are widely applied in the field of machine learning classification algorithms. These assist the machine learning classification algorithm in deciding whether the measurement motion parameter pattern fed to its input can be classified into the signal body gesture category (i.e. whether the user has really given a signal body gesture according to the decision unit), or a signal body gesture cannot be recognized and therefore the pattern is not classified into this category.

In case the signal body gesture is made with the intention of issuing an alarm, then the alarm is raised by the system if a signal body gesture is safely recognized (rules related to the signal body gesture, e.g. to the number and strength of foot stamps made immediately following one another can be established and trained beforehand to the decision unit, see below in more detail).

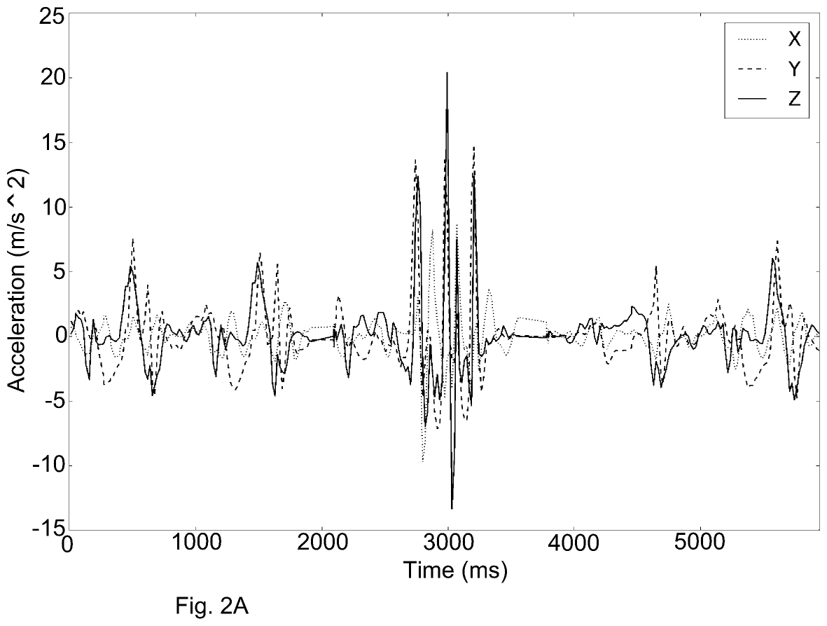

In FIG. 2A the diagram of an exemplary acceleration-time function corresponding to a triple foot stamp recorded by a mobile device is shown. In FIG. 2B the significant portion of the signal, i.e. the portion corresponding to the foot stamps, is shown in a zoomed-in view (a shorter period is shown). As shown in the diagrams, it is the central portion of the functions shown in FIGS. 2A and 2B that corresponds to the signal body gesture (in this case, a triple foot stamp). The two figures show the same exemplary signal shape, with the origin of the X-axis being shifted in FIG. 2B relative to FIG. 2A (it is shifted closer to the analysed part of the signal).

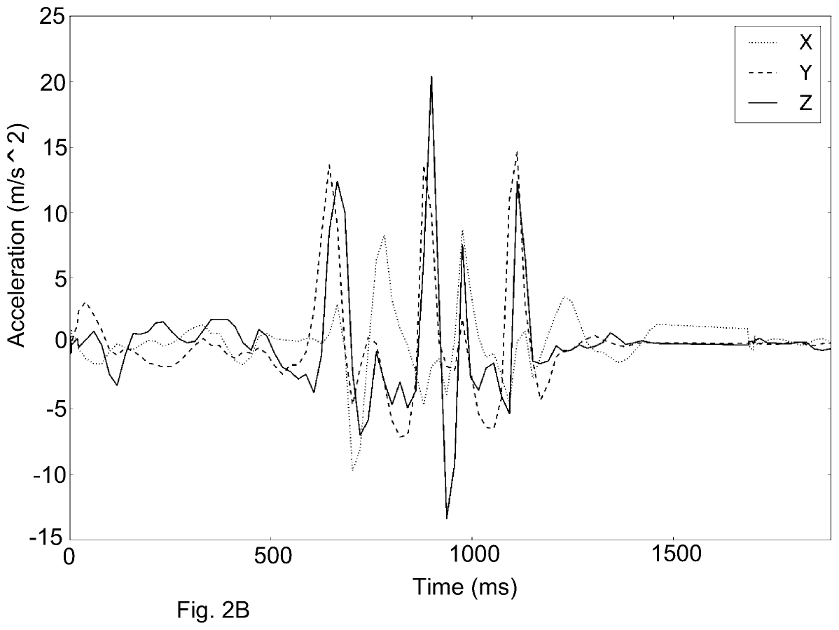

In FIG. 3A orientation is shown as a function of time; orientation values illustrated in the figure are recorded for the same sample (and for a period of the same length) that is illustrated in FIG. 2A: in FIG. 3A there can be seen that at the time coordinates corresponding to the foot stamps (around 3000 ms) some variations in orientation can also be observed. In FIG. 3B orientation values are shown over the same (shorter) period that is shown in FIG. 2B. Orientation values (in degrees) are given relative to a predetermined position. Orientation values sometimes fluctuate between +/−180°. This is because in this case the mobile device has an orientation that is very close to the origin of at least one coordinate axis, so for even small modifications of the actual position the corresponding value may fluctuate between the positive and the negative extreme values. Therefore, mostly in addition to acceleration, orientation may also be a motion parameter.

As illustrated also on FIGS. 2A and 2B, it is expedient to apply a triple foot stamp as signal body gesture (as opposed to single or double foot stamps) because triple foot stamps (or those in a larger number) can be separated from the background signal (coming e.g. from walking) much better than single ones. As it is illustrated in these figures, the separability of a triple foot stamp is significantly better even compared to a double foot stamp.

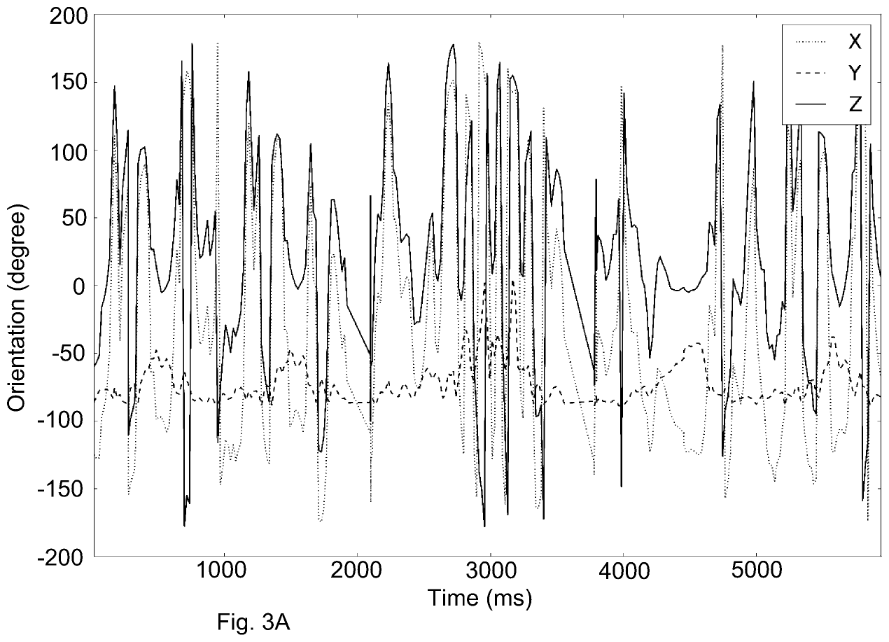

The diagrams in FIGS. 2A and 2B show the three different-direction acceleration components as a function of time. For describing the acceleration components, expediently a coordinate system fixed to the mobile device is applied. Such an exemplary coordinate system is illustrated in FIG. 4. In FIG. 4 the mobile device 100 is shown in front view. The mobile device 100 is illustrated in FIG. 4 schematically, therefore a screen 102 and push button 104 of the mobile device 100 are shown in a schematic manner. Of course, any mobile device of a different configuration can be applied according to the invention provided that it comprises a kinetic sensor capable of recording motion parameters; the kinetic sensor is therefore typically located in the mobile device.

The coordinate axis directions illustrated in FIG. 4 are, therefore, the following: If the mobile device 100 is displaced in a sideways direction relative to its front side, the displacement is along the X-axis. The vertical movement of the mobile device 100 takes place along the Y-axis. The Z-axis lies at right angles with respect to these axes (and to the front side of the mobile device 100), so for example a movement in the direction of the Z-axis is the tilting of the mobile device 100.

In case of a coordinate system fixed to the mobile device, the coordinate system of course moves together with the mobile device. It is therefore dependent on the orientation of the mobile device whether, in case of a signal body gesture (i.e. by way of example, a foot stamp) one or another acceleration component is expected to increase. For example, in the case depicted in FIG. 1A the mobile device 100 is located essentially vertically (in case the outerwear is positioned normally on the user's body, i.e. the part containing the pocket is not kept in a non-natural position, e.g. flipped upwards for a long time). The mobile device 100 is shown in a vertical orientation also in FIG. 1B, but in a bag 22 it can also be resting on its face or back, and with a smaller bag—similar to the one illustrated in the drawing—the orientation of the bag itself when carried by the user 20 can also be uncertain. In the position (not shown here) when the mobile device is carried simply in the user's trouser pocket, in the basic position (with the user standing and ready to perform a foot stamp) it is oriented vertically to a good approximation (i.e. its longitudinal axis is nearly vertical) because modern mobile devices do not fit in a trouser pocket in a laid-down position (i.e. their longitudinal axis is horizontal).

However, as can be understood contemplating FIG. 2A, the orientation of the mobile device at the time of performing the signal body gesture is essentially irrelevant. Of course, the more information is known on the mobile device, especially on the way it is carried, the better its behaviour can be evaluated. Therefore, labels describing the way the mobile device is carried (“in bag”, “in pocket”, etc.) can be preferably applied during training; training utilizing such data can be advantageous for the purposes of recognition (see in more detail below).

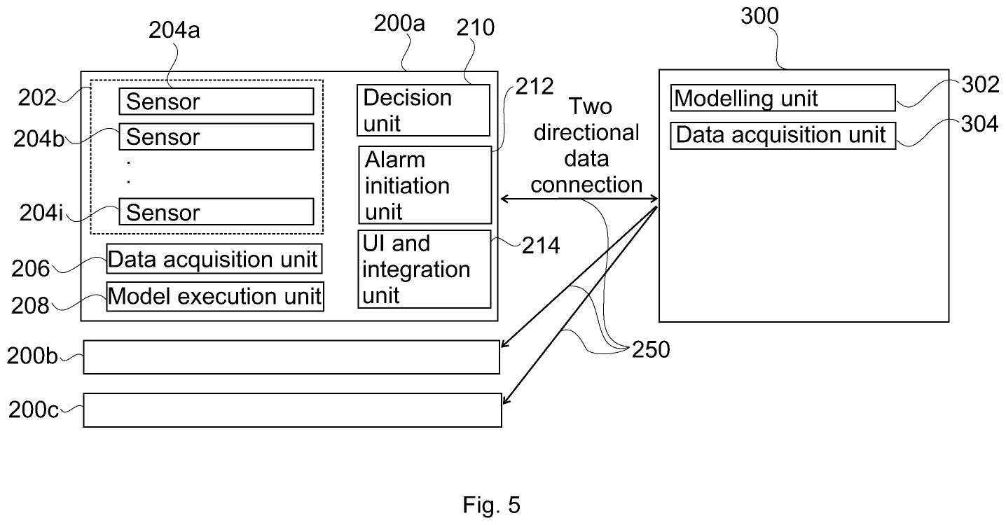

Besides that, the machine learning algorithm-based, suitably constructed evaluation model of the decision unit (e.g. the model according to FIG. 7 or other models with a more complex structure) can be trained such that it can be expected to equally recognize foot stamps with the device being carried in a bag and in a pocket (it will therefore be a so-called “common” model). According to our experience, models trained this way are capable of recognizing foot stamps with a similar accuracy to models trained only for pockets or bags.

The effectiveness of a common model depends on the same parameters as separate models, i.e. on the tuning of the model structure and on the amount and quality of training data. From the aspect of data a common model has the significant advantage compared to separately trained models that in this case the network can be trained utilizing a much greater amount of data at the same time. Therefore, if we have the same amount of data for a pocket-carried and a bag-carried device, then twice as much training data is available for the model relative to the separately trained case.

In FIGS. 2A and 2B such a situation is illustrated wherein the mobile device is in the user's trouser pocket. When the mobile device is carried for example in a suit pocket or a bag, the signal shape will differ from the shape illustrated in FIGS. 2A and 2B in that the amplitude of the measured signal will be lower, and, due to the different orientation of the mobile device higher acceleration values will appear on a different coordinate axis.

As shown in the figures, especially in FIG. 2B, over the signal portion in the central part of the figure (where the highest acceleration values can be seen) it is the Z-direction acceleration that has the highest value, while Y-direction acceleration has also increased significantly (almost reaching the Z-direction values). The resulting signal shape is caused essentially by the factors detailed below.

In the figure a signal corresponding to a triple foot stamp is shown. When a foot stamp is started, the Z-direction acceleration increases in accordance with that the mobile device is moved in the Z-direction (as the users lift their thigh it is turned in the Z-direction) when the leg is lifted before stamping (in FIGS. 1A and 1B the leg of the users 10 and 20 is shown in this lifted state prior to stamping). An Y-direction acceleration is also produced during the movement because the mobile device is displaced also in a vertical direction (it is put in the pocket in an upright position rather than laying on its side), and the above mentioned motions are accelerating motions. X-direction acceleration is lower than the acceleration measured in the other two directions, however, X-direction acceleration can occur due to various reasons. One of these reasons is that the users do not always lift their leg for stamping in a strictly forward direction (i.e. the leg may also move sideways). In addition to that, the device can be placed in the pocket slightly sideways (i.e. turned towards one side of the user, not strictly in front of or behind the user). It may also happen that the mobile device is displaced (slightly tilted in the X-direction) inside the pocket as a result of the foot stamp, in which case a non-zero X-direction acceleration will occur.

The instance when the user starts the stamping motion in an upward direction from substantially zero acceleration can also be observed contemplating the signal shown in the diagram (in FIG. 2B the part of the diagram can be observed more closely thanks to the magnification). During the movement acceleration first increases and then returns to a near-zero value when the thigh attains its highest point and momentarily stops. After that the user's leg accelerates downwards (towards the ground), followed by the acceleration value returning to near zero when the foot hits the ground.

A similar signal shape can be observed in relation to the subsequent foot stamps; and the signal shape is also similar for Y- and Z-direction accelerations. As far as

Z-direction acceleration is concerned, the middle foot stamp is the most intense; with the three foot stamps (i.e. the peaks corresponding to each foot stamp) being more or less similar with respect to Y-direction acceleration.

Thanks to the longer time period shown, in FIG. 2A the “normal” motion is also shown on which the foot stamps are superposed. As it is discernible from the signal shape, the user is walking, suddenly performing a triple foot stamp, and then returning to walking again. It can be discerned contemplating FIGS. 2A and 2B that the duration of the triple foot stamp is approximately 750 ms, i.e. it is performed in under a second. It is also shown in the diagrams that the peak acceleration values corresponding to the foot stamps are between 10 and 25 m/s², the peak value being slightly over 20 m/s².

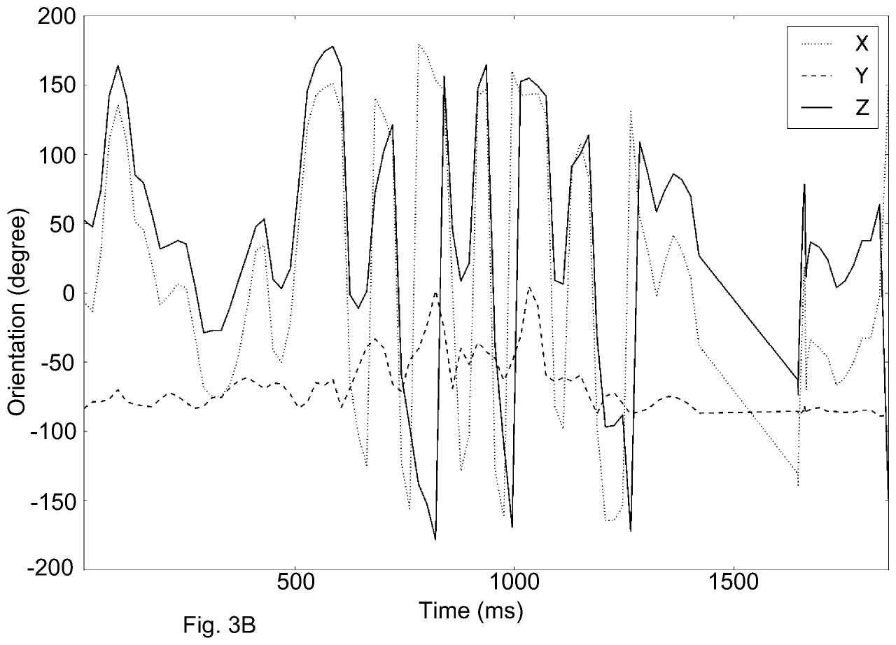

FIG. 5 is a block diagram illustrating an embodiment of the system according to the invention. In the embodiment according to FIG. 5 the system comprises mobile devices 200a, 200b and 200c, to which a server 300 is connected via (wireless) bidirectional connections 250. FIG. 5 shows the schematic diagram of the components of the mobile device 200a, with the mobile devices 200b and 200c being shown schematically.

The mobile device 200a comprises kinetic sensors 204a, 204b, . . . , 204i in a sensor unit 202 (sensor module). For example, one of these sensors is an acceleration sensor suitable for measuring different directional components of acceleration. Commercially available sensors consist of a single hardware component that is utilized for recording acceleration components along all three axes. This type of sensor is built into most mobile phones by phone manufacturers. The mobile device 204a further comprises a data acquisition unit 206 (data acquisition module) and a model execution unit 208 (model execution module). The mobile device 204a also comprises a decision unit 210; the decision unit can also be called an evaluation unit. According to the invention the decision unit 210 applies a machine learning classification algorithm for categorization; since the decision unit 210 is arranged in the mobile device 200a, it can be operated off-line (without an internet connection).

The embodiment of the system shown in FIG. 5 is a system responsible for alarm, i.e. this embodiment of the system is adapted for issuing an alarm signal upon recognizing the signal body gesture. Accordingly, the embodiment of the system shown in FIG. 5 comprises an alarm initiation unit 212 (alarm initiation module). The mobile device 204a further comprises a UI (user interface) and integration unit 214 (UI and integration module). The other mobile devices 204b and 204c can be of a similar design. The server 300 comprises a modeling unit 302 (modeling module) and a data acquisition unit 304 (data acquisition module).

According to the invention, the signal (measurement motion parameter pattern) is processed on the one hand in a rule-based manner, applying analytic methods (the decision unit is operated in case the given measurement motion parameter pattern possesses values being equal to or exceeding a predetermined signal threshold value), and, on the other hand, utilizing a machine learning/classification algorithm (by way of example, random forest algorithm, deep feed-forward/convolution/feedback neural networks, hidden Markov chains, SVM [support vector machine], etc.). During a machine learning-based processing the system is trained to best identify the events of high importance applying data (training data) recorded in relation to our solution.

The signal body gesture may e.g. be a foot stamp (foot stamp exercise); the signal body gesture may also be a different foot gesture. The duration of performing the signal body gesture is preferably 0.1-5 seconds, particularly preferably 0.4-2 seconds. The signal body gesture can be applied e.g. for initiating an alarm.

A stamping exercise consists of a predetermined number of foot stamps carried out with a predetermined force, executed in a given time period. The exemplary triple foot stamp is started by bending the knee and carried out with the entire sole of the foot over a period of 1-3 seconds. During stamping, the sole of the foot is hit against the ground when the foot lands on it. For better sensitivity it is expedient to apply as strong a stamp against the ground as possible. If the foot stamp is carried out with the entire sole of the foot, the point of application of the compressive force corresponding to the stamp is—to a good approximation—located at the centre of the sole. The typical maximum value of the compressive force is 1-10 N during the foot stamp (occurring typically when the foot lands on the ground). Foot stamps are typically performed with the same side foot as the side where the mobile device is carried. Other regions of our body are also affected when performing the foot stamp, so an acceleration can be detected by the mobile device (smart phone, tablet etc.)

Analysing prior art approaches and during our own research it has been established that rule-based systems can be operated with severe restrictions. In our system, therefore, rules are applied primarily for filtering out extreme cases (this is the reason why detection threshold value is applied). This is necessary because events occurring only occasionally during everyday use (e.g. the phone is dropped once a day) can deteriorate the accuracy of machine learning algorithms.

In our system, the number of false alarms can be reduced applying rule-based filtering also during the operation of the machine learning algorithm. The estimations yielded by our machine learning algorithms are therefore taken into account if the probability values specified for a time window are above a predetermined probability threshold value (typically between 75% and 95%); see below for a more detailed description.

The signals (motion parameter patterns) are preferably processed applying a sliding window method, with a typical overlap of between 50% and 95% between subsequent measurement time windows. Accordingly, a time window is preferably succeeded by the next one with an overlap (i.e. the subsequent time window does not start after the current one but overlaps with it). The degree of overlap is preferably at least 50%, i.e. the time windows overlap for half of their duration; but the degree of overlap can also be very high, even 95%, in which case the subsequent time window is barely shifted temporally with respect to the earlier one due to the great overlap. It is not expedient to apply an overlap over 95%. Within the range specified above the greater the overlap, the better (e.g. 75-95%), so that a given motion parameter pattern can be analysed as many times as possible. However, for lower-performance mobile devices the processing of so many time windows can be an impossible challenge, so in such cases the degree of overlap can be reduced to as much as 50%. Accordingly, the degree of overlap between subsequent time windows is therefore preferably changed in an adaptive manner depending on the performance of the mobile device running the solution.

In this embodiment, in the decision unit the evaluation model (which can be simply called a model) based on the machine learning algorithm analyses each motion portion more than once due to the overlaps resulting from the sliding window technique (the structure of an exemplary evaluation model is shown in FIG. 7). In each of these analyses, i.e. for all time windows following each other (that are overlapping due to the sliding window technique) a recognition result is supplied by the evaluation model, specifying the probability of the data being analysed (the motion parameter pattern belonging to the time window) originating by way of example from a triple foot stamp, i.e. of it corresponding to a signal body gesture. Let us therefore call this recognition result as occurrence probability.

Due to the overlaps between the time windows, more than one temporally close time windows can be evaluated by the applied evaluation model as containing a foot stamp with a probability of x (which can be given as a percentage or as a number between 0 and 1). The analysis of these probability values enables establishing rules that can be preferably used for reducing the number of false alarms.

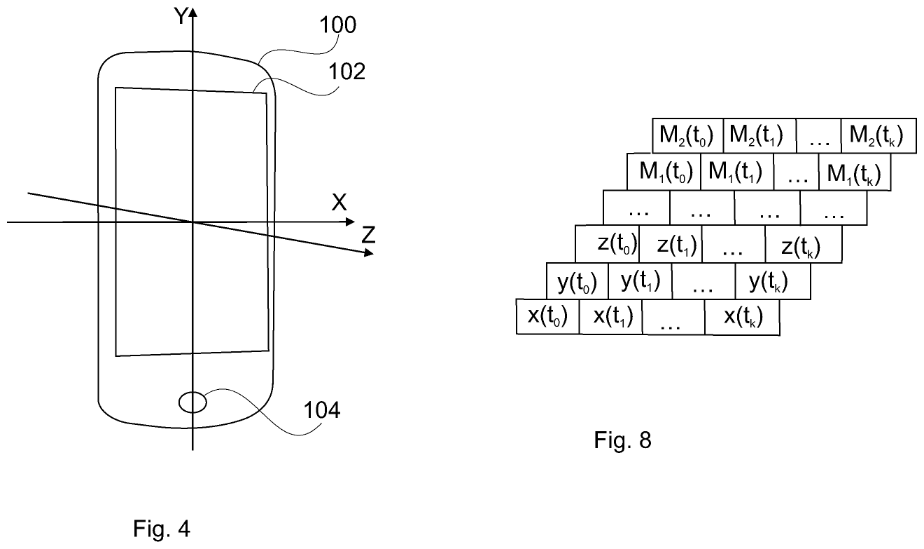

In FIG. 6 the components of acceleration (i.e. the x-, y-, and z-direction components of acceleration) are illustrated as a function of time; at 4000 ms a signal corresponding to a triple foot stamp can be observed. In FIG. 6 measurement time windows 350, 355, 360 are designated that are fed sequentially to the evaluation model applied by the decision unit 375 (the same evaluation unit is applied for all time windows 350, 355, 360). Each time window 350, 355, 360 is assigned a respective occurrence probability p₁, p₂, p₃ specifying the probability (estimated by the model) of an event corresponding to a signal body gesture occurring in the given time window 350, 355, 360, i.e. in this case, whether the given time window comprises a signal shape corresponding to a triple foot stamp.

It is an essential aspect of the sliding window approach that each data point recorded by the appropriate sensor (the motion parameter pattern falling into a respective time window) is evaluated by the model not only once but several times. This is expedient because without an overlap such a situation may occur (cf. FIG. 6) when the first time window is between 0 and 4000 ms, and the second between 4000 and 8000 ms. In this case the signal corresponding to the triple foot stamp shown in FIG. 6 would be cut in two, i.e. the signal to be recognized as a foot stamp could never be seen in its entirety by the evaluation model, which would be a problem. Accordingly, the advantages of the sliding window approach are illustrated by FIG. 6 in itself.

If, however, a 3-second overlap (in general a 75% overlap) is applied, as shown in FIG. 6, then the foot stamp signal (corresponding to a triple foot stamp) appears in its entirety in all of the time windows corresponding to the time periods of 1000-5000 ms, 2000-6000 ms and 3000-7000 ms, implying that it can be processed efficiently by the evaluation model. It also follows from the above that according to this approach, three prediction results (occurrence probability values) being close to each other may indicate that a (triple) foot stamp was performed in the given time window, i.e. that the given time window comprises the signal body gesture. Generally, the width of the time window is chosen such that the signal corresponding to the signal body gesture can (well) fit into it in its entirety. Accordingly, the width of the time window (as an adjustable parameter) is chosen to be 1.5-10 times, preferably 2-4 times the width of a signal shape corresponding to a typical signal body gesture (the borders of the signal are defined by a predetermined decay). For example, the duration of a triple foot stamp is 1.2-2 seconds, and a time window with a width of 4 seconds is assigned to it.

In this embodiment, therefore, the machine learning algorithm of the decision unit (built, for example, applying neural network) yields not only a yes/no output, but also probability values, for which threshold value rules can be established according to the following. In the example illustrated in FIG. 6, measurement time windows comprising 200 samples (samplings, measurement data) are applied; in the example the time window covers a duration of 4000 ms. In the example the overlaps amount to 150-190 samples (3000-3800 ms; in FIG. 6 an overlap of 3000 ms is shown, but a greater overlap can also be applied). Window size and the degree of overlap may vary.

The rules pertaining to the occurrence probabilities are preferably tuned in the following manner. With the established rules the prediction results (i.e., when analysing multiple overlapping time windows, the occurrence probabilities corresponding to each of the time windows; the occurrence probabilities specifying the chance of finding a signal body gesture in the given time window) corresponding to labeled foot stamps, that is, to the measurement time windows containing them are analysed. The occurrence probabilities corresponding to the time window group being analysed are preferably ordered in descending series (order) and it is checked whether they exceed a predetermined probability threshold value (that may be dependent on the location within the series), for example in a manner described below. This is illustrated below by the help of an example.

In an example, in addition to the one being currently analysed, two earlier (sequentially overlapping) time windows are taken into account for deciding if the signal body gesture falls into a given time window. In general, the time windows in the group being analysed overlap such that even the last one is slightly overlapping with the first (or, to put it in another way, even the very first window overlaps with the one currently analysed), i.e. the members of the time window group being analysed can be regarded as belonging to the interval of a given time window. In the example, therefore, three probability threshold values correspond to the three time windows being analysed (a respective probability threshold value is assigned to each). In an example, let these probability threshold values (probability thresholds) be [0.9; 0.8; 0.8]. In this case the condition for classifying a time window as comprising a signal body gesture is that each one of the occurrence probabilities that are assigned to the time windows by the evaluation model and are sorted by magnitude should be greater than the corresponding probability threshold value also sorted by magnitude. Alternatively, more than three (by way of example, five) successive time windows (with at least the ones immediately following one another being overlapping, or all windows being overlapping to some degree) can also be applied. In such a case it has also proven expedient to apply, for example, only three probability threshold values, and only the three largest occurrence probabilities (of the occurrence probabilities corresponding to the more than three time windows) are required each to be greater than a respective one of the three threshold values (sorted by magnitude). That is, using the values of the above example, the largest one should be greater than 0.9, the second largest greater than 0.8 etc. For the rest of the occurrence probability values (in this example, for the other two) there are no requirements.

In another possible case, the smallest prescribed threshold value is already smaller, for example, 0.3-0.4 (may be less than 50-75% of the largest threshold value). In the example related to three time windows being analysed, this smallest threshold value may belong to the middle one; therefore in such a case the signal body gesture is detected—because the other two probability threshold values are relatively high—even if the occurrence probability is lower for some reason in an intermediate time window (it is not desirable to lose these signal body gestures).

In an embodiment, therefore, in addition to the given time window, the occurrence probabilities assigned to at least two adjacent earlier time windows are also taken into account for the analysis of the given time window, but, according the above, sorting them in a descending series, only a smaller number (compared to the number of time windows being analysed, and thus the number of occurrence probabilities assigned to them) of the greatest occurrence probability values are compared with a respective probability threshold value. Fulfilling this comparison condition (the occurrence probabilities reach or exceed the respective probability threshold values) is sufficient for determining that a signal body gesture is detected by the system in the given time window (for example, it is accepted as a foot stamp).

Such cases, wherein all of the occurrence probability values are above the predetermined number of probability thresholds, are called “true positive” examples, such examples are also applied for training the machine learning algorithm.

Cases like this can also occur with false alarms. If such a falsely detected signal body gesture is found for which—preferably within the period of a time window (with overlaps)—the three greatest foot stamp probability values exceed the three probability limits, then it is a so-called “false positive” case (this is a problem, it leads to a falsely positive decision, i.e. it is a false alarm). The probability threshold values should be adjusted such that this happens as rarely as possible.

If, on the other hand, at least one of the occurrence probabilities does not fulfill the conditions, then it is a so-called “true negative” case. The aim is to obtain such cases, thereby reducing the number of false alarms (i.e. to adjust the probability threshold values such that the results are “true negatives” rather than “false positives”). Thus, the aim is to find a point of equilibrium for the probability threshold values (i.e. a set of probability threshold values) with which an acceptable number of real foot stamps are not detected (i.e. such foot stamps may occur that are under the established probability threshold values) while at the same time the number of “false positives” are reduced below an acceptable limit. This can be achieved by fine-tuning the probability threshold values.

In the above described embodiment of the system according to the invention, therefore, the decision unit (a probability sub-unit thereof that can preferably be regarded to perform the above described functionality) is adapted for assigning an occurrence probability characterising a probability of an occurrence of the signal body gesture based on a measurement motion parameter pattern corresponding to a respective measurement time window to each of the measurement time windows, and the classification of a measurement motion parameter pattern corresponding to a given time window to a signal body gesture category is decided by means of the decision unit based on a comparison of occurrence probabilities assigned to the given measurement time window and at least one previous (preceding) measurement time window with probability threshold values assigned to the measurement time windows, (that is, the comparison between the occurrence probabilities assigned to the time windows taken into account and the probability threshold values—either all or some of them—assigned to the time windows taken into account), wherein the given measurement time window and the at least one previous measurement time window are subsequent to each other (follow each other) and at least the pairs overlap each other (in case of a high degree of overlap, more than two time windows may overlap, such a situation is illustrated in FIG. 6).

In line with the above, the decision unit is adapted for making a decision on only one time window (the last one) at a time, however, it can preferably re-classify all members of the group into the signal body gesture category in case it is established for the given group based on the probability threshold values and the occurrence probabilities that a signal body gesture can be found in the time windows thereof. However, the signal body gesture is considered to be identified—and can for example lead to an alarm signal—if the probability criteria are fulfilled; and, if this happens with the time window being currently analysed, then the categories into which earlier time windows are finally classified is less relevant, what is important is that the signal body gesture has been detected.

In the above described embodiment, furthermore, the occurrence probabilities assigned to the given measurement time window and to at least one previous measurement time window are preferably arranged (ordered) in descending series (order) by the decision unit (or by a probability sub-unit forming a part thereof)—where the series is a monotonic descending one, i.e. the probability with the next index is smaller than or equal to the previous one—, and each of at least a part of the occurrence probabilities from the beginning of the series is compared with a probability threshold value corresponding to the position with gradually (ever) increasing serial number in the series, respectively (see the above example, according to which in a preferred case the threshold value is adjusted to suit the largest probabilities among the time window being simultaneously analysed, the rest being disregarded). In this embodiment, furthermore, the probability threshold values corresponding to positions with gradually increasing serial number are gradually smaller than or equal to the previous value (i.e. the probability values sorted in descending order are compared with monotonic descending probability threshold values).

In addition to the system, the invention also relates to a method for detecting a signal body gesture. The method comprises the steps of
recording a measurement motion parameter pattern corresponding to the time dependence of a motion parameter of a mobile device in a measurement time window by means of a kinetic sensor, and
by means of a decision unit applying a machine learning classification algorithm subjected to basic training by means of machine learning with the application of a training database comprising signal training motion parameter patterns corresponding to the signal body gesture, deciding on classifying the measurement motion parameter pattern to a signal body gesture category, operating the decision unit in case the measurement motion parameter pattern having a value being equal to or exceeding a predetermined detection threshold value (according to the operating condition, in order that a classification decision can be made the measurement motion parameter pattern has to be equal to or exceed the detection threshold value, i.e. during the method the decision unit is applied for making decisions on only those measurement time windows which contain measurement motion parameter patterns being equal to or exceeding the detection threshold value, which implies that about motion parameter patterns falling below the detection threshold value it is directly determined that these do not belong to the signal body gesture category).

Accordingly, the method for detecting a signal body gesture is analogous with the system for detecting a signal body gesture, and thus certain functionalities of the system can be formulated as steps of the method. The method adapted for training the system (more accurately, the machine learning classification algorithm of the system's decision unit) can also be applied for training the machine learning classification algorithm applied in the method for detecting a signal body gesture.

In an embodiment, therefore, the motion parameter patterns can be preferably processed (in a manner slightly analogous with the above considerations) by preferably responding to an alarm event (i.e. if the motion parameter pattern is classified into the signal body gesture category by the decision unit) by issuing an emergency signal (i.e. more generally, by taking (a) further step(s) based on the pattern having been categorized into the signal body gesture category) in case in the length of the time window (typically 1 and 5 seconds; this is the time window where the signal body gesture is first recognized; i.e. this is meant by the “interval corresponding to the time window”, see above for the interpretation of that) output values relating to alarms with sufficiently high probability values are received from the machine learning classification algorithm in relation to at least 2-5 processed time windows. It is not absolutely required to apply further steps when the motion parameter pattern is classified into the signal body gesture category, and these further steps (if any) are not necessarily steps for issuing an emergency signal (the signal body gesture can be applied for issuing various other signs or for performing other tasks such as controlling an application). To achieve this, time windows with an appropriate degree of overlap have to be utilized. There will be at least two time windows fall (at least partially) into the duration of the time window corresponding to the first detection event in case the degree of overlap is at least 50%. At least five time windows fall (get) in the same way if the degree of overlap between the time windows is at least 80%. With an overlap higher than that, the condition for issuing the emergency signal is fulfilled in case a signal body gesture does not occur in not all of the overlapping time windows in the course of the time window corresponding to the first detection event. For issuing an emergency signal, it is therefore required to detect—with high confidence, as provided by the above described method—that the user has given a signal body gesture.

Depending on the use mode, two different preliminary filtering sessions are performed on the data: if the device is carried in a pocket, then the foot stamp detection based on a machine learning classification algorithm is started only for sensor data exceeding 5-50 m/s² (preferably 5-15 m/s², more preferably 5-10 m/s²), while in case the device carried in a bag, it is started if the sensor data exceed acceleration values of 1-30 m/s² (preferably 1-15 m/s², more preferably 1-10 m/s²), i.e. the detection threshold value is set for the user accordingly. If the carrying mode of the user cannot be established, the lower one of the two values is chosen.

In an embodiment of the system according to the invention, therefore, with acceleration being applied as a motion parameter and a foot stamp being applied as a signal body gesture, the detection threshold value is 1 m/s², if the mode of carrying the device can be established, for example, by the help of metadata, then the detection threshold value is 1 m/s² for a bag-carried device, and 5 m/s² for a device carried in a pocket. The decision unit according to the invention is therefore operated in case the measurement motion parameter pattern (which in this case is an acceleration-time signal shape) has a value that is equal to or exceeds this threshold value. If the signal body gesture is another type of body movement, such as an indirect knock on the mobile device, a different detection threshold value may expediently be selected, however, our experiments have shown that a threshold value of 5 m/s² is also appropriate for a triple knock on a mobile device that is being carried in a pocket.

The reason for applying these acceleration limits is that, with a device carried in the pocket, acceleration values of at least 20-40 m/s² were recorded in relation to the recorded movement sequences indicating an emergency. In case the mobile device was carried in a bag, lower-magnitude acceleration events were measured than with pocket-carried devices (both when recording a “non-event” signal and when observing alarm-inducing events), probably due to higher damping caused by the bag hanging from the user's body. Due to the various damping effects it is expedient to set up different threshold values. In this way filtering out events that have similar signal shape to alarm events but are much weaker, and thus could be erroneously classified by the system as alarms, can be successfully filtered out. This can also be applied for improving the energy efficiency of the system by preventing the machine learning classification algorithm from processing data unless there is an event involving significant bodily movement. For these reasons it is especially preferable to combine rule-based and machine decision making. After rule-based processing, therefore, the emergency signal is identified by means of machine learning methods.

In an embodiment of the invention, for classifying to the signal body gesture category, the values of the measurement motion parameter pattern, as well as short-term summation data (short-term memory data) and long-term summation data (long-term summation data) obtained at time instants of the measurement time window by summing up the values of the motion parameter or a power of the absolute values of the motion parameter over a short-term summation period (short-term memory length), and a longer (i.e. longer than the short-term summation period) long-term summation period (long-term memory length), respectively, are applied in the decision unit.

Of course, as it was mentioned above, the motion parameter can be acceleration (or even acceleration and orientation) also in this embodiment and in other embodiments as well. Even certain acceleration components can be regarded as motion parameters, in which case the summation thereof and the summed up values thereby obtained should be taken, and can be fed to the decision unit, in a component-by-component manner. In many sections of the description, acceleration is taken as a motion parameter.

In the present embodiment, in addition to the raw sensor data measured by the kinetic sensor (e.g. acceleration components), so-called “relevancy-highlighted” parameters are also fed to the inputs of the machine learning classification algorithm (e.g. a DNN network), which greatly improves the effectiveness of the machine learning classification algorithm. The application of relevancy-highlighted parameters can be combined with the above described probability approach, i.e. the use of occurrence probabilities and probability threshold values.

According to the invention, the decision algorithm—which is for example a decision algorithm based on a neural network—evaluates measurement motion parameter patterns corresponding to the temporal function of the motion parameter in a measurement time window. Accordingly, the input of the decision algorithm is the portion of the temporal function of the motion parameter function falling into a given time window, i.e. the motion parameter pattern. Since the sampling frequency is (of course) finite, this portion of the function is represented by a given number of function values. The values of the motion parameter are therefore provided to the decision algorithm in relation to a time series, and, based on that, the algorithm then decides whether the motion parameter pattern corresponds to a signal body gesture or not.

However, as it is described in detail below, in this embodiment, relevancy-highlighted data are also fed to the input of the decision algorithm in addition to motion parameter values, i.e. the highlighted data constitute additional inputs.

An example (also mentioned above) for a value-highlighted parameter that can be fed expediently to the input of the algorithm are long-term summation data and short-term summation data. As it was also mentioned above, summation data are prepared by summing up the powers of the values or absolute values of the measured data (e.g. acceleration) over a given summation period, i.e. for example, summation is performed applying the values themselves (first power), their squares (second power) or their absolute values (also the first power). The length of the measurement time window corresponding to the motion parameter pattern is chosen such that a signal body gesture (e.g. a triple foot stamp) can fit inside it. In case a triple foot stamp is applied as a signal body gesture, but also for other signal body gestures, the length of the time window is typically 1-5 seconds. The long-term summation period is preferably a multiple of the length of the time window, preferably 20-40 seconds, with the value being typically set to 30 seconds. The short-term summation period preferably has a similar length as the length of the measurement time window, i.e. preferably 1-5 seconds, typically 3 seconds. In an embodiment of the system according to the invention the length of the long-term summation period is 5-15 times, particularly preferably 8-12 times the length of the short-term summation period (the exact value may vary depending on the model being applied; for the best model described in this document a value of 10 is applied, as described above).

In an embodiment, the definition of the long-term summation data is:

$${M}_{1} = \frac{1}{{N}_{2} - {N}_{0} + 1} {\sum }_{i = {N}_{0}}^{{N}_{2}} {x}^{2} ( i ) ,$$

where N₀ is the start of the analysed sample series, N₂ is the end of the long-term memory of the analysed sample series, x denotes the acceleration values measured along the various axes, and N₂−N₀+1 denotes the number of samples analysed in the long-term memory.

In an embodiment, the definition of the short-term summation data is:

$${M}_{2} = \frac{1}{{N}_{2} - {N}_{1} + 1} {\sum }_{i = {N}_{1}}^{{N}_{2}} {x}^{2} ( i ) ,$$

where N₁ is the start of the short-term memory of the analysed sample series, and N₂−N₁+1 denotes the number of samples being analysed in the short-term memory. The parameters M₁ and M₂ can be calculated separately for each axis, and also by summing up the acceleration values (not only by applying a square sum). The parameters obtained are fed to the input of the machine learning classification algorithm besides the raw motion parameter values obtained for the time series, with a respective M₁ and M₂ parameter being associated with each time instant. In addition to the motion parameters, the relevancy-highlighted parameter values over the entire analysed time window (i.e. not only e.g. certain peak values) are also fed to the input of the machine learning classification algorithm. Of course, in this case the training of the machine learning classification algorithm involves providing these data to the algorithm. Applying this approach, accuracy can be improved by 3-6%.

The short-term and long-term summation data are adapted for highlighting the changes in the data (relevancy highlighting). Summation data are obtained by summing up the values (or a power, usually the square, of the values) of the parameter that forms the basis of the analysis (in this embodiment it is acceleration, or the axial components thereof). Short-term summation data comprise the summed-up values immediately preceding the analysed time instant. Long-term summation data comprise the summed-up values of the same parameter over a (much) longer period. Therefore, short-term and long-term summation data is applied for comparing recent behaviour with behaviour over a longer period. The value of the summation data adapted for describing long-term behaviour is preferably a value undergoing only a slow change, from which the value of the short-term summation data strongly differs in case high peaks of the analysed motion parameter have been measured recently. Accordingly, these cases can be preferably applied for using foot stamps as a signal body gesture, where typically high values occur in the motion parameter pattern (see FIG. 2A). Similar values may occur in case of knocking on the device, so the above described approach can be preferably applied in the embodiment applying knocks as a signal body gesture.

Because in case foot stamps are applied as signal body gestures the mobile device is expected to undergo negative acceleration in some direction (moving legs up and down with the mobile device located in our pocket or bag is subjected, for example, also downward and upward direction accelerations), it is expedient to sum up the square of acceleration values for relevancy highlighting. When applying a simple sum, i.e. when summing up the values themselves, high values with opposite sign could cancel out each other, but in this way these values are surely represented in the summation value. It will be understood that the absolute value of the parameter values or a higher even power thereof can likewise be summed up for obtaining the summation data with the above purpose.

In the table below (Table 1) it is shown how the parameters M₁ and M₂ (long-term and short-term summation data) are assigned to the given time instants. The rows of Table 1 denote subsequent time instants (t₀, t₁, . . . ), the values x, y, z denote acceleration values associated with the given time instant (measured along the given coordinate axes), while M₁, M₂ denotes the long- and short-term summation data, respectively, corresponding to the given time instant. The t_{N0} denotes the start of the long-term summation period being analysed currently (at the time instant t_{N2}), t_{N1} is the start of the short-term summation period (the parameter values are summed up for the summation data starting at these time instants); while t_{N2} denotes the end of both summation periods and the data series comprising the most current measured values (the current time instant).

The values M₁, M₂ are calculated for each time instant (for each row of Table 1). If a sufficient number of past samples is not available (in the case of the initial time instants) then values of the missing rows are filled up with zeroes. In other words, if the summation operation cannot reach back to a sufficient number of past values for calculating the summation data—for example because no motion parameter values were recorded by measurement at those instances—then the missing values are filled up with zeroes. As an alternative, such an approach could also be taken according to which a decision is not made until we reach t_{N2}.

TABLE 1

| | Acceleration | | | Values calculated for this embodiment | |
|---|---|---|---|---|---|
| Time | X | Y | Z | M₁ | M₂ |
| t₀ | x(t₀) | y(t₀) | z(t₀) | M₁(t₀) | M₂(t₀) |
| t₁ | x(t₁) | y(t₁) | z(t₁) | M₁(t₁) | M₂(t₁) |
| t₂ | x(t₂) | y(t₂) | z(t₂) | M₁(t₂) | M₂(t₂) |
| . . . | | | | | . . . |
| t_{N0} | . . . | | | | . . . |
| . . . | | . . . | | | . . . |
| . . . | | | . . . | | . . . |
| t_{N1} | | | | . . . | . . . |
| . . . | | | | | . . . |
| t_{N2} | . . . | . . . | . . . | ${M}_{1} ( {t}_{N 2} ) = \frac{1}{{N}_{2} - {N}_{0} + 1} {\sum }_{i = {N}_{0}}^{{N}_{2}} {x}^{2} ( i )$ | ${M}_{2} ( {t}_{N 2} ) = \frac{1}{{N}_{2} - {N}_{1} + 1} {\sum }_{i = {N}_{1}}^{{N}_{2}} {x}^{2} ( i )$ |

As illustrated also in Table 1, as with the acceleration values, the values of M₁ and M₂ are also calculated at every time instant. E.g. t₀−t_{N2} illustrates only an arbitrarily chosen period (values can be recorded also for earlier time instants), but t₀ can also be the starting point of the entire data recording process. In this latter case, according to the definition no acceleration values are available for time instants prior to t₀.

The arguments (t₀, t₁, . . . ) of the M₁ and M₂ values included in Table 1 indicate the time instant to which the given value belongs, i.e. the last time instant in memory that has to be taken into account for summation. If, therefore, the values M₁ and M₂ are calculated for the time instant t₀, then t₀ will be the time instant corresponding to N₂, with the time instant N₁ preceding it by as many time instants as the parameter value, and the time instant N₀ being located still earlier. The calculation is performed this way in case we have some values preceding t₀, if it is not so, then zeroes are substituted everywhere for the variable x in the sum, and so in this latter case the value of both M₁ and M₂ is 0 at the time instant t₀. In case there are no values preceding t₀ then mostly zeroes are summed up at the following few time instances. As soon as t_{N0} “exceeds” t₀, that is, as soon as t_{N0} comes after t₀ in the summation, the zero values that in this case precede to will not be part of the summation any more.

The M₁ and M₂ values can be calculated for each time instant in an analogous manner; in Table 1 the situation corresponding to the time instant N₂ is illustrated (indicating t_{N0} and t_{N1} with respect to t_{N2} that is listed last). In this time instant it is no longer necessary to reach back for calculating M₁ to the full data series but only as far back as the time instant t_{N0} (and to N₁ for calculating M₂).

The sensor data (X, Y, Z-direction acceleration values) corresponding to the time instants falling inside the measurement time window and the M₁ and M₂ values are fed to the input of the neural networks that are for example applied as the machine learning classification algorithm. The values falling inside the measurement time window are called the motion parameter pattern (in this embodiment, acceleration pattern), so in this embodiment, beside the motion parameter pattern, the M₁ and M₂ values are also utilized by the machine learning classification algorithm for the categorization of the motion parameter pattern. From the aspect of the neural network the M₁ and M₂ values are similar to sensor data (i.e. measured acceleration (components)), i.e. each of them constitutes a single input.

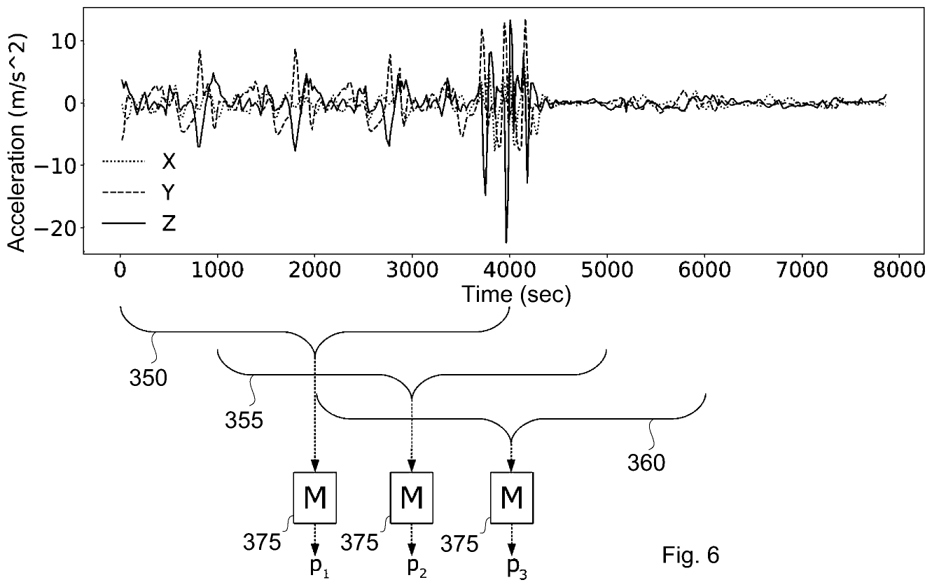

For analysing a single measurement time window with a typical length of 1 and 5 seconds (values corresponding to a single time window are fed to the input of the machine learning classification algorithm, i.e. the machine learning classification algorithm is applied for analysing the time window) the data have to be expediently transformed to the matrix format illustrated in FIG. 8 (due to the interface of the applied neural network architecture) so that they can be fed to the input of the network. The values of each parameter corresponding to successive time instants are therefore put in the rows of the matrix (in FIG. 8 the X-direction acceleration values are put at the bottom, the Y-direction values being added above them, and so on). Likewise, the short- and long-term summation data corresponding to each time instant are added to the upper rows of the matrix illustrated in the figure. The dotted row of the matrix illustrates that further variables (e.g. data from light sensors or thermometers if they are relevant for the decision) and even further motion parameters (e.g. orientation change) can also be taken into account and can be fed for evaluation to the input of the machine learning classification algorithm.

M₁ and M₂ values (and also the weighted inputs described later on) can therefore be analysed this way. In FIG. 8 the start and end of the measurement time window is denoted by t₀ and tₖ, respectively, where the length of the measurement time window is k.

In addition to the above described approach based on summed up data, a further approach for relevancy highlighting is to feed the sensor data to the input of the algorithms in an axis-by-axis manner and weighted and/or summed up such that information that is more relevant for the given task is highlighted therein. In an embodiment of the method according to the invention, therefore, in the decision unit components of the measurement motion parameter pattern are taken into account weighted according to relevance for classifying to the signal body gesture category.

Such an example is described by the following expression: \sqrt{(2z)²+y²}. In this case, for a phone being carried in a pocket, lateral movements are disregarded, while forward/backward movements are taken into account with double weight.

Table 2 below shows an example for calculating the above mentioned weights. The first column of Table 2 shows the successive time instants, columns 2-4 show values (measured with the accelerometer) corresponding to the given time instant. In the fifth column the acceleration values corresponding to the given time instant are shown substituted in the above weighting expression.

TABLE 2

| | Acceleration | | | |
|---|---|---|---|---|
| Time | X | Y | Z | Weighted input |
| t₀ | x(t₀) | y(t₀) | z(t₀) | {square root over ((2z(t₀))² + y(t₀)²)} |
| t₁ | x(t₁) | y(t₁) | z(t₁) | {square root over ((2z(t₁))² + y(t₁)²)} |
| t₂ | x(t₂) | y(t₂) | z(t₂) | {square root over ((2z(t₂))² + y(t₂)²)} |
| t₃ | x(t₃) | y(t₃) | z(t₃) | {square root over ((2z(t₃))² + y(t₃)²)} |

Input values obtained this way can be fed likewise to the network by transforming them to the above described matrix format (FIG. 8, the weighted input will be in a separate row).

In certain embodiments of the method according to the invention, personalizing (customization) data are recorded from an end user preferably after completing basic training (in most cases, personalization (adapting to a person; individualizing, customization) is carried out after basic training, when it is not, notice will be given), and the machine learning classification algorithm of the decision unit is personalized for the end user based on the personalizing data. In other words, in certain embodiments of the invention the machine learning classification algorithm of the decision unit is personalized (in particular by further training or by specifying, based on the acquired data, the model applied in the algorithm) for the end user applying data acquired from the end user. Because mobile devices are typically used only by one person during their whole service life, it is particularly preferable to personalize the system (i.e. the algorithm applied for making a decision) for this end user, since there is no added advantage if the system is capable of operation (i.e. can detect issuing a signal body gesture) with a wider range of users, likely with somewhat lower accuracy; it has to operate as accurately as possible for the end user.

The aim of personalization for a given end user is to improve recognition rate for signal body gestures (real motion gestures), as well as to reduce the occurrence of false alarms (when a motion parameter pattern is falsely categorized into the signal body gesture category), i.e. to improve the overall accuracy of the system. According to the present approach, personalization can be carried out taking into account (1) the motion parameters of the end user (by the help of at least one personalizing motion parameter pattern acquired from the user), or (2) the personal characteristics of the end user (that are for example given at the time of registering for using the system).

In particular embodiments of the method according to the invention—as it will be indicated below in the description of the embodiments—at least one personalizing motion parameter pattern corresponding to the signal body gesture is recorded from the end user as personalizing data.

In this case, therefore, personalization is performed on the basis of the motion parameters of the end user, i.e. at least one motion parameter pattern (called a personalization pattern) recorded from the end user. In the following, a number of possible ways of carrying out personalization are presented, however, personalization can also be conceivably carried out in various ways. In the course of the personalization process based on motion parameters, data are recorded from the user applying the kinetic sensor (utilized also during the operation of the system) before the user would start using the system according to the invention. These data allow the system to better learn the motion parameters of the user (i.e. to be “trained for” the end user). Personalization applying the data acquired from the user can be carried out in various ways, with some particular possible ways (embodiments) being presented below.

For performing personalization, the personalizing motion parameter pattern has to be preferably recorded from the end user in such a manner that the signal portion corresponding to the signal body gesture can be identified easily. As it is described below, the end user preferably performs the signal body gesture as a response to a request issued by the system, and therefore it can be easily identified. Acquiring the personalizing motion parameter pattern from the user sheds light on how the given end user performs the signal body gesture; the movements corresponding to the signal may have several features specific to each end user; the end user's bodily characteristics and the user's own interpretation of how to give the gesture sign may all appear in the signal. Accordingly, performing personalization based on the recorded personalizing signal may have a beneficial effect on recognizing signal body gestures issued by the end user during real (normal) operation, and also on minimizing the number of false recognitions.

Thus, sensor data can be preferably acquired for personalization by utilizing a so-called synchronization mode, which means that data are recorded for a predetermined period of time (typically 2-5 minutes). During this period the user can preferably perform normal activities—including e.g. walking, doing housework, etc.—while the application running on the system indicates to the user (performs a data entry request) via the mobile device by making a sound and/or vibration when the signal body gesture, that is, for example, the motion gesture consisting of a predetermined number of foot stamps, has to be performed.

Requests to the user (data entry requests) asking the user to perform the signal body gesture so that it can be recorded as a personalizing motion parameter pattern are made at random time intervals, but preferably with a separation of at least 15 seconds. Thus, in a single recording period preferably more than one personalizing motion parameter patterns can be recorded, i.e. applying this method a sufficient amount of labeled training data applicable for personalization can be acquired in a short time. In this embodiment, therefore, the at least one personalizing motion parameter pattern is recorded from the end user after a respective data entry request of the system.

Personalization, i.e. the so-called adaptation process can be carried out in a number of ways, that is, various approaches can be applied for utilizing the data recorded with the help of the synchronization mode or the at least one personalizing motion parameter pattern recorded in other way; in the following particular embodiments will be described. It holds true for all of the below listed embodiments that for the personalization process performed in the particular embodiments, at least one personalizing motion parameter pattern corresponding to the signal body gesture is recorded from the end user as personalizing data.
1. In an embodiment of the method according to the invention, during the personalization of the machine learning classification algorithm of the decision unit for the end user, the machine learning classification algorithm having been subjected to basic training is subjected to further training by machine learning applying the at least one personalizing motion parameter pattern.
   The machine learning classification algorithm that has typically been trained (subjected to basic training) based on a large number of users, and thus can be termed a generic algorithm is fine-tuned based on data acquired from the target user (i.e. based on the at least one personalizing motion parameter pattern). By fine-tuning it is preferably meant that the machine learning classification algorithm that has already been trained (subjected to basic training) is trained further applying data gathered from the target user, followed by a control measurement of accuracy applying the original user database and the data gathered from the target user, continuing the fine-tuning process until accuracy exceeds a threshold level.
2. In a further embodiment of the method applying personalization based on a further personalizing motion parameter pattern, a neural network-based machine learning classification algorithm is utilized in the method, and, during the further training,
   weights of a neural network-based machine learning model corresponding to the machine learning classification algorithm subjected to basic training are left unchanged,
   complementary layers are inserted into the neural network-based machine learning model, and,
   the at least one personalizing motion parameter pattern is applied for subjecting the complementary layers to further training by machine learning.
In this embodiment, thus a neural network-based machine learning classification algorithm is applied. In general, a machine learning model (a model corresponding to machine learning, algorithm model) corresponds to the machine learning classification algorithm (not only with machine learning classification algorithms based on a neural network) that is generated during training (for example from an initial machine learning model). During training the structure of the network remains the same, only the weights of the network are modified. For personalization such methods are also suggested wherein the structure of the network is changed, but only once (by adding complementary layers), followed by “further training” during which only the weights are modified. With neural networks the machine learning model is essentially characterised by the structure of the layers, and the weights of the interconnections between the layers and between the neurons/processing units within the same layer. When a neural network is applied, the algorithm model is further characterised by the following:
   layer types,
   parameters of the layers,
   interconnections between the layers,
   error function,
   optimization algorithm and its parameters,
   initialization method of the network.
   In this embodiment, therefore, the weights (weight values) generated earlier are left unchanged during further training (i.e., as with variant 1 above, a pre-trained generic machine learning model is used as a starting point, but the weights of the existing machine learning model are left unchanged during further training). Further training is performed by inserting new layers onto the neural network, followed by subjecting these new layers to further training, i.e. by preferably training them such that the machine learning model obtained as a result works for the target user (end user) with as high accuracy as possible.
3. In this embodiment, too, at least one personalizing motion parameter pattern corresponding to the signal body gesture is recorded from the end user as personalizing data, and, during the personalization of the machine learning classification algorithm of the decision unit for the end user, a machine learning model corresponding to the machine learning classification algorithm of the decision unit is left unchanged, and the machine learning classification algorithm is subjected to basic training by machine learning utilizing the training database comprising the training motion parameter patterns, as well as utilizing the at least one personalizing motion parameter pattern.
   In contrast to the methods 1 and 2 above, this embodiment does not involve fine-tuning of a trained algorithm, but the data recorded from the target user during personalization are utilized already during the basic training of the machine learning model having a predetermined structure (i.e. in this embodiment the data recorded for personalization are utilized already for the basic training). In this case the target user's data can also be weighted such that these training samples are taken into account by the system during training with increased weights. Therefore, in this embodiment, during the basic training—performed in a delayed manner, after recording the personalizing motion parameter patterns—, the at least one personalizing motion parameter pattern is preferably taken into account with larger weights compared to the training motion parameter patterns.
4. As with the methods 1-3 above, in this embodiment, too, at least one personalizing motion parameter pattern corresponding to the signal body gesture is recorded from the end user as personalizing data. In addition to that, during the personalization of the machine learning classification algorithm of the decision unit for the end user, the machine learning classification algorithm is subjected to basic training by machine learning utilizing the training database comprising the training motion parameter patterns, as well as utilizing the at least one personalizing motion parameter pattern, and the machine learning model corresponding to the machine learning classification algorithm of the decision unit is generated during the basic training.
   In this embodiment, therefore, basic training is performed according to method 3 above, however in this case the neural network to be trained has no predetermined structure, but the structure that best models the data set complemented by the target user's motion parameters is generated applying a hyperparameter optimization method (see in detail below).

In addition to or instead of taking into account the motion parameters, personalization can be performed by classifying the (end) users into groups according to certain features. In this case it is made use of that particular user groups (such as women/men, old (women/men) or young (women/men)) may possess similar motion parameters.

In an embodiment of the invention, accordingly, the machine learning classification algorithm has respective group-level machine learning models (machine learning models belonging to groups) corresponding to at least two user parameter groups formed according to user parameters, and
a personal (individual) user parameter value of the user parameter that is characteristic of the end user is recorded from the end user as personalizing data,
the end user is classified, during the personalization of the machine learning classification algorithm of the decision unit for the end user, to one of the at least one user parameter groups based on the personal user parameter value, and
the group-level machine learning model corresponding to the group is applied according to the classification in the machine learning classification algorithm of the decision unit.

In our system, the model having the highest performance for a particular group is put into operation for persons in the given group, i.e. there is a respective group-level machine learning model corresponding to each user parameter group (group generated based on user parameters) which exhibits good performance for the group, and is assigned to the group during personalization. Grouping is therefore preferably based on metadata (personal user parameter values) specified during the registration process. This involves that users enter some data (user parameters), by way of example their sex or age.

For the application of this method a set of models is previously generated which performs better in relation to a particular user group relative to the generic model, and thus a personalized (customized) model can be selected for each user already at the end of the registration process.

Grouping can be based, for example, on sex, age, or the way the users carry their mobile phone, but, as it will become apparent, for classifying the end users into groups some of the deeper characteristics of the user's motion can also be taken into account. A model specifically chosen in this way yields extremely good results for the vast majority of users.

In a further, extremely effectively applicable embodiment of the method according to the invention, classification into groups is performed based on the at least one recorded personalizing motion parameter pattern according to the following:

In this embodiment, the machine learning classification algorithm has respective group-level machine learning models corresponding to at least two user parameter groups formed according to user parameters (as with the above described embodiment, such models are also applied here), and the system further comprises an auxiliary (additional) decision unit having an auxiliary (additional) decision algorithm adapted for classifying into the at least two user parameter groups, and the method further comprising the steps of
recording from the end user as personalizing data at least one personalizing motion parameter pattern corresponding to the signal body gesture, and,
during the personalization of the machine learning classification algorithm of the decision unit for the end user,
the end user is classified to one of the at least two user parameter groups by means of the auxiliary decision unit based on the at least one personalizing motion parameter pattern, and
in the machine learning classification algorithm of the decision unit, the group-level machine learning model corresponding to the group according to the classification is applied.

Accordingly, the problem of classification into groups can also be approached such that a given user is not classified into a given group based on personal characteristics (user parameters) but rather based on data recorded during the personalization step. Machine learning methods (machine learning classification algorithms) are applied for this, but the auxiliary decision unit, unlike the (basic) decision unit that is adapted for differentiating motion gestures from normal activities (i.e. detects the signal body gestures), is adapted for classifying the users (into groups) based on the recorded personalizing motion parameter patterns. For example, these can be called primary and secondary, or first and second decision units and decision algorithms. Applying this embodiment of the method can prevent such situations where, for example, an elderly person who moves like a young person would be classified into the group of elderly people based on his or her age (if just this piece of personal data was taken into account for personalization). This makes the present embodiment, which according to the above applies a decision mechanism based on machine learning algorithms at two levels, i.e. for classifying users and for differentiating motion gestures from normal activities, very advantageous and effective.

Particular embodiments of the invention relate to a method for issuing a signal (for signaling), in particular an alarm signal. In the course of this method a measurement motion parameter pattern is recorded by means of the kinetic sensor of an embodiment of the system according to the invention, by means of the decision unit of an embodiment of the system according to the invention, a decision is made on classifying the measurement motion parameter pattern into the signal body gesture category, and, if the measurement motion parameter pattern has been classified into the signal body gesture category by the decision unit, the signal is issued. This embodiment therefore relates to a method for issuing a signal, in the course of which the measurement motion parameter pattern given by the user is analysed, and, if it is classified by the decision unit into the signal body gesture category, the signal is issued.

A further embodiment of the invention relates to a mobile device application which is controlled by a signal issued by means of the method for issuing a signal according to the invention. A still further embodiment relates to a method for controlling a mobile device application, and during the method the mobile device is controlled by a signal issued by means of the method for issuing a signal according to the invention. The issued signal is therefore applied, for example, for controlling an application for a mobile device.

An embodiment of the invention relates to a method for recording data, the data recording method comprising the steps of marking starts of signal training motion parameter patterns corresponding to signal body gestures of a training database applied for machine training by pushing a button of an earphone set or headphone set of a mobile device recording the training motion parameter patterns (i.e. by a separate press of the button at the start of each training pattern) or by means of a recording sound signal, (by sound control, giving a special sound signal, e.g. shouting, i.e. the change to the signal body gesture is made directly), or recording each signal training motion parameter pattern corresponding to a signal body gesture of the training database after a respective data entry request of the system (i.e. the change to the signal body gesture is made indirectly).

According to the latter option (data entry request) therefore, the input of the signal training motion parameter patterns can also be requested by the system, i.e. the signal body gesture is performed by the user after receiving some kind of request to do so from the system. An “entry request” can be indicated by the system for example by an auditory and/or vibration signal by the mobile device (the mobile device vibrates when the next signal body gesture is to be performed). Such “entry request” has an important role for example in the case of hearing impaired users, who are thus enabled to use the system according to the invention (data entry requests can be indicated applying auditory/vibration signals also in case of personalization). An “entry request” is essentially a category change: the system changes from the “other” label/category (e.g. walking) to the “signal body gesture” (e.g. foot stamp) label/category, and from this point a new label corresponds to the recorded signal. Finishing of the signal body gesture is typically automatic (the signal label is flipped back): a limited amount of time is provided by the system for performing the signal body gesture, after which the system returns to the “other” category.

An embodiment of the data recording method further comprises the step of also marking the end of each signal training motion parameter pattern corresponding to a signal body gesture by pushing the button on the earphone set or headphone set of the mobile device or by means of a recording sound signal. Data are recorded in such a manner also in an embodiment of the system and the training method.

Applying the data recording method according to the invention, very preferable data labeling of the data can be achieved, thus for filling in the training database, by pressing the button the one or more users are allowed to signal when they are actually intend to make the movement that corresponds to the signal body gesture. Thereby the signal section intended by the user to be a signal body gesture can be identified much better. For still more accurate selection (labeling) the end of the pattern can also be marked, this, however, is not absolutely necessary; for example a typical length (which generally matches the typical actual duration of the signal) can also be specified for the signal body gesture.

There are two major possibilities for applying machine learning/classification methods for signal processing: In the first case the input data are subjected to various signal processing methods (preprocessing), so-called characteristic extraction algorithms, followed by modeling applying the data resulting from these algorithms. The advantage of this method is that—provided that the characteristic extraction algorithm is selected advantageously with respect to the task to be performed—the complexity of modeling can be reduced. If the characteristic extraction results in as good or even better-quality data compared to modeling without parameter extraction, and if the combined computational demand of parameter extraction and the reduced-complexity machine learning model is lower compared to the model not including characteristic extraction, then a system with improved efficiency can be obtained. In the second case the raw data are directly transferred to the machine learning algorithm that undergoes a so-called characteristic training process (which can theoretically yield better results compared to analytic parameter extraction), and simultaneously with that also performs modeling.

Raw data are first introduced into the characteristic extraction unit (characteristic extraction module), where the input data are transformed applying one or more parameter extraction algorithm. The characteristic extraction algorithm usually reduces the number of variables; resulting in a more compact abstraction of the input parameters that is expected to be better described later on by the modeling algorithm. Exemplary parameter extraction (preprocessing) algorithms are listed in Table 3 below.

TABLE 3

Fast Fourier Transform
Mel-Frequency Cepstral Coefficients
Re-sampling at lower frequencies
10-base logarithm
Wavelet transformation
Frequency-domain correlation calculation
Time-domain correlation calculation
Frequency and time-domain correlation calculation

The algorithms listed in Table 3 can be applied for characteristic extraction in a known way; the application of the particular methods in relation to characteristic extraction is described in the following publications: Fast Fourier Transform: Cochran, W. T., Cooley, J. W., Favin, D. L., Helms, H. D., Kaenel, R. A., Lang, W. W., . . . & Welch, P. D. (1967). What is the fast Fourier transform?. Proceedings of the IEEE, 55(10), 1664-1674. Mel-Frequency Cepstral Coefficients: Molau, S., Pitz, M., Schluter, R., & Ney, H. (2001). Computing mel-frequency cepstral coefficients on the power spectrum. Proceedings of IEEE International Conference on Acoustics, Speech, and Signal Processing ICASSP 2001 (Vol. 1, pp. 73-76). Wavelet: Daubechies, I. (1990). The wavelet transform, time-frequency localization and signal analysis. IEEE transactions on information theory, 36(5), 961-1005.

The preprocessed data obtained in the above manner are transferred to machine learning algorithms adapted for classification, such exemplary algorithms are listed in Table 4.

TABLE 4

Random Forest
Support Vector Machine
Feed-forward neural network
Logistic regression
Linear regression

A challenge related to the method is to find the appropriate combination of the algorithms and their settings. In particular cases the number of possibilities was reduced based on theoretical considerations, followed by a so-called brute-force search for the best settings applying a high-performance server machine.

An example implemented by us and described below has been tested. In the example, a neural network was applied in the decision unit; the structure of which is specified below. It is also presented below how the training was carried out in the system according to the example. In the example personalization was not performed (applying personalization accuracy may be improved even further), but derived parameters (short- and long-term summation data) were used. The results obtained through testing are illustrated by the confusion matrix included in Table 5 below.

TABLE 5

| | | OTHER | |
|---|---|---|---|
| | FOOT | (walking, | |
| Estimated | STAMP | etc.) | Total |
| Real | | | |
| FOOT | 2317 | 39 | 2356 |
| STAMP | | | |
| OTHER | 329 | 11416 | 11745 |
| (walking, etc.) | | | |
| Total | 2646 | 11455 | 14101 |

| | |
|---|---|
| Accuracy: | 0.973902560102 |

The rows of the confusion matrix included in Table 5 illustrate the real class, the columns illustrate the estimated class. There are two classes appearing in Table 5; in the example, the “foot stamp” class corresponds to the signal body gesture category. In addition to that, a category labeled “other” (walking, etc) also appears, signals that cannot be classified into the “foot stamp” category are taken here (in the example, such patterns are analysed wherein the task was to differentiate between a foot stamp applied as a signal body gesture, and walking), i.e. moving around by car or by bicycle, standing still, using public transport (train, bus, tram), and any other signals not belonging to the signal body gesture.

The values in the main diagonal of the matrix give the number of correctly processed samples. The main diagonal should be interpreted for the 3×3 section comprising only numbers. The main diagonal comprises the number of cases wherein the estimation matched the actual event, i.e. when the system recognized correctly whether the given signal corresponds to a foot stamp, and which signal should be classified into the “other” (walking, etc.) category. The matrix also shows results indicating that the result of estimation was classifying the event into the “other” category, but in reality, there was a foot stamp (39 events), and also such results when the estimation classified the event as a foot stamp but in reality, there was another type of event, e.g. walking (329 events). The table also shows summations. It is also shown that the ratio of false categorizations was relatively low, and therefore in the particular example accuracy was more than 0.97. Thanks to the performed back measurements, the confusion matrix is able to show how accurate the particular instances of classification are for the particular categories.

Table 6 below includes a summary of test results obtained for the example. In

Table 6 a number of accuracy test metrics are calculated for each class (foot stamp, other) of the given particular model (for the applied metrics see:). The bottom row comprises the average of the values obtained applying the metrics, weighted by the number of samples. For example, the “precision” metrics is calculated as follows: (2356*0.88+11745*1)/(2356+11745)=0.9799, where 2356 is the full number of real foot stamps, and 11745 is the total number of real events classified into the “other” category according to Table 5 above.

TABLE 6

| | precision | Recall | F1-score |
|---|---|---|---|
| FOOT STAMP | 0.88 | 0.99 | 0.93 |
| OTHER (walking, | 1.00 | 0.97 | 0.98 |
| etc.) | | | |
| avg/total | 0.98 | 0.97 | 0.97 |

Following the paradigm of deep learning in our approach, characteristic training and modeling are carried out in a single step, and thus the two fundamental components of the model can closely cooperate.

In the example, the so-called backpropagation algorithm (LeCun, Y. A., Bottou, L., Orr, G. B., & Müller, K. R. (2012). Efficient backprop. In Neural networks: Tricks of the trade (pp. 9-48). Springer Berlin Heidelberg.), based on neural networks, is applied as a learning algorithm, in conjunction with an adaptive stochastic gradient method called the ADAM algorithm (Kingma, D., & Ba, J. (2014). Adam: A method for stochastic optimization. arXiv preprint arXiv:1412.6980.).

For modeling non-linear temporal relations, this algorithm (for an illustration of the algorithm see FIG. 7) applies recurrent layers (FIG. 7, recurrent layers 408 and 416), convolution layers (FIG. 7, convolution layer 414) for characteristic learning and forward-connected layers (FIG. 7, fully-connected layer 406) for implementing classification in the neural network. For regularization, so-called batch normalization and dropout layers are applied which in all cases appear in the architecture directly preceding the activation function (FIG. 7, activation functions 404 and 412). In addition to that, L1 and L2 regularizations are also applied during training. For stopping the training process the validation error is monitored; training was stopped when the error did not decrease further for another 100 training cycles (epochs).

The other approach applied in addition to characteristic extraction and modeling is based on the characteristic learning process of the so-called deep neural networks; this is applied also in this example. In this case the inputs of the machine learning classification algorithm are the raw data themselves (i.e. preprocessing or characteristic extraction is not applied), the machine learning classification algorithm simultaneously performing the learning of the parameters characteristic of the data and also modeling. This can also be interpreted as if the parameters best describing the data were extracted for the machine learning classification algorithm.

In the network applied in the example (see FIG. 7 and the parameters given below), a given number of one- or multidimensional convolution layers (and the corresponding activation functions) can be optionally followed by a so-called pooling (e.g. max-pooling or average pooling) layer (FIG. 7, pooling layer 410). Either preceding or following the convolution layers (FIG. 7, convolution layer 414) there are included recurrent layers (FIG. 7, recurrent layers 408, 416, e.g. Long Short-Term Memory, LSTM: Hochreiter, S., & Schmidhuber, J., Long short-term memory. Neural computation, 9(8), 1735-1780 (1997)) primarily for modeling temporal behaviour. Like in this example, the network is typically (but not necessarily) terminated by (a) feed-forward, so-called fully connected layer(s) (fully connected layer 406). The generic block diagram, further specified below for the example herein described, is shown in FIG. 7.

Values xR, xK, xP, xS and xF in FIG. 7 denote how many instances of a particular layer type are included in the network. These values may range from 0 to an arbitrary value; the numbers applied in our example are given below. Usually zero or one pooling layer is included in each block. With a large number of hidden layers, efficient training requires the residual/skip type interconnections shown in the left of the figure (in the example presented below no such interconnections are applied, but they can be preferably included in the network), due to which the gradient value does not vanish during error backpropagation (in our model, depending on the concrete implementation, this problem is tackled by applying the so-called “residual”, “highway”, or “dense” network types). In order to prevent exploding gradients, gradient cutting is applied.

Finding the appropriate network architecture and parameter settings poses a serious challenge also in the case of deep learning-based models. The batch normalization and dropout layers adapted for regularization are not shown separately in FIG. 7 (they can be included preceding or following any layer; in the case of our example the layer sequence presented below is applied). Our experiments indicate that the model herein presented exhibits robustness, and even with default settings it provides better results compared with the approach based on characteristic extraction.

The accuracy that can be achieved applying the below described exemplary architecture is illustrated, for data recorded from a single user, in Table 6 above, that is, applying for example the “precision” metrics, an accuracy value of 98% is obtained. Therefore, the rate of false alarms can be reduced to a negligible level.

The layer sequence applied in the example is presented in the following, with reference to the layers of network 400. Layer 1 is the input layer (FIG. 7, input layer 418), layer 13 is the output layer (FIG. 7, output layer 402). Based on FIG. 7, the corresponding parameters are xR=0 (accordingly, a recurrent layer 416 is not included in the exemplary network), xK=2, xP=2, xS=1, xF=2. The compulsory components of the architecture are preferably the following: input layer, output layer, and at least one from among the blocks R, K, P, S, and F, i.e. the blocks assigned to the numbers xR, xK, xP, xS and xF. The subscript indices of the numbers xR, xK, xP, xS and xF below denote which elements of the particular blocks are constituted by the given layer.

Layer 1: 1-dimensional convolution, filter size: 10, filter depth: 16, step size: 1, activation: ReLU [Input layer=Convolution layer, xP₁, xK_{1,1}, i.e. the input layer is the convolution layer of the blocks with these indices]

Layer 2: 1-dimensional convolution, filter size: 4, filter depth: 32, step size: 2, activation: ReLU [Convolution layer, xP₁, xK_{1,2}]

Layer 3: batch normalization

Layer 4: 1-dimensional max pooling, step size: 2 [Pooling layer, xP₁]

Layer 5: 1-dimensional convolution, filter size: 6, filter depth: 32, step size: 2, activation: ReLU [Convolution layer, xP₂, xK_{2,1}]

Layer 6: 1-dimensional convolution, filter size: 1, filter depth: 8, step size: 1, activation: ReLU [Convolution layer, xP₂, xK_{2,2}]

Layer 7: batch normalization

Layer 8: 1-dimensional max pooling, step size: 2 [Pooling layer, xP₂]

Layer 9: Long Short-Term Memory, 16 LSTM cells, activation: sigmoid [Recurrent layer, xS₁]

Layer 10: feed-forward layer, 256 neurons, activation: ReLU [Fully-connected layer, xF₁]

Layer 11: dropout

Layer 12: forward-connected, 128 neurons, activation: ReLU [Fully-connected layer, xF₂]

Layer 13: forward-connected, 2 neurons, activation: sigmoid [Output layer]

The 1D convolution is a layer type typically applied for processing time series-like data. In the 1D case, for mutually close sample points only the “adjacency” characteristics is defined (preceding/following). For comparison, image data are already usually processed applying 2D convolution, in which case proximity is interpreted already over a 2D plane (e.g. left/right/bottom/up). Because we have a time series data, 1D convolution is applied.

The filter should be interpreted as follows: Let us consider e.g. a time window with a length of 100 samples. This time window can be analysed applying e.g. a filter having a length of 10 (filter size is 10). This filter (having a length of 10) is shifted from left to right over the 100 samples applying the specified step size. The depth of the filter gives the number of dimensions onto which the filter of the given width maps the samples. From the aspect of convolution, this still remains 1D.

The activation function allows that the mapping performed by the layers is something more complex (“smarter”) than a simple linear mapping. It may be e.g.: relu, sigmoid, softmax, tan h, etc. (ReLU: Rectified Linear Units).

For training and testing machine learning classification algorithms the kind of training data is of key importance. In the case of the above example, the training data preferably comprise the following parameters as sensor data: X-, Y-, and Z-direction acceleration and orientation, with a sampling frequency of 50 Hz. Accordingly, the same data are measured and taken into account by the system also for recognizing the signal body gesture.

Our experiments indicated that in some cases recognition can be improved if, in addition to acceleration—applied in our case as a basic motion parameter—the temporal function of orientation is also utilized as a motion parameter. However, in other cases this has not brought about any improvement, i.e. in certain situations this additional data cannot be effectively used by the system; the reason for this may be that the measured data contain too many “jumps” between +/−180 degrees that is shown also in FIGS. 3A and 3B. The orientation sensor, being adapted for measuring orientation, gives information on the position of the mobile device (e.g. how it is oriented inside the pocket, i.e. upside down or not).

In the example, training data are assigned labels corresponding to the current activity, e.g.:

“walking”,

“foot stamp, pocket”,

“foot stamp, bag”.

The label “foot stamp, pocket” indicates that the device (mobile device) was carried in a pocket, the label “foot stamp, bag” indicating that the device was in a bag. In the data labeled “walking” no signal sections corresponding to foot stamps can be found; such data are preferably also applied for training that represent the signal types received by the algorithm during periods when no signal body gesture (e.g. foot stamp) is performed. As with the above mentioned “other” category (walking, etc.), here the “walking” category can include everything that does not particularly correspond to a signal body gesture (i.e. sitting, standing, walking etc.), but these can also be labeled separately, in which case the machine learning classification algorithm can even be trained for sub-categories under the “other” category.

Therefore, training also includes training utilizing mobile devices carried in different ways; the data are preferably labeled with the carrying mode being applied (“in bag”, “in pocket”, etc.). During the preferably included personalization process, it is on the one hand possible to enter the carrying mode of the mobile device as registration metadata (assisting the selection of the appropriate machine learning model for classification), and on the other hand, carrying habits can be inferred by comparison with the at least one personalizing motion parameter pattern, and the machine learning model can also be structured accordingly. Personalization is of course applied only as an option, the machine learning classification algorithm trained applying various different signals (patterns) is preferably capable of deciding on which carrying mode is being utilized also without it, and can process the signal applying the appropriate machine learning model.

In the above example, data are labeled during the phase of recording training data, preferably by pressing a function button located on a headset cord of the mobile device. After recording, the data are checked manually. In the example the amount of data included in Table 7 were applied for the training process. This is considered the minimum amount of data required for setting the basic parameters (it can be seen in FIG. 7 that 1841 foot stamp events (triple foot stamps) were recorded with a device carried in a pocket, and 1837 such events were recorded with a device carried in a bag). During training, 90% of the data was utilized for training, 5% for validation and 5% for testing.

TABLE 7

| | |
|---|---|
| Number of persons | 13 |
| Walking (pocket) | 617 minutes |
| Walking (bag) | 720 minutes |
| Foot stamp (pocket) | 50 minutes, 1841 events |
| Foot stamp (bag) | 43 minutes, 1837 events |

As it was mentioned above, personalization can also be preferably applied during training. For example, every new user can be asked to record 10-10 triple foot stamp gestures as a personalizing motion parameter pattern, corresponding to the typical carrying habits of the particular user (i.e. with the phone carried in a pocket or a bag), which pattern will then be applied for performing personalization by modeling software running on the remote server. The 10 instances of triple foot stamps can be recorded either applying the above described so-called synchronization mode, i.e. such that a signal is given by the system when the triple foot stamp gesture is to be commenced. The model adapted for the given user is sent back to the evaluation (decision) unit of the mobile device. In situations where the accuracy of the generic model is not adequate, applying personalization based on the personalizing motion parameter pattern accuracy can be improved significantly (according to our experiments, for some users by as much as 2-10%).

Designing deep neural networks involves setting a large number of parameters appropriately for optimal results. Different parameter settings yield significantly different results as far as the accuracy of the networks is concerned. Parameters may include the structure of the network (how many and what types of layers, the layer sequence, how many neurons in each layer, window size of the convolution layers, number of convolution filters, type of interconnection between layers, activation functions, etc.), and the combinations of raw sensor data and relevancy highlighted parameters fed to the input can also be optimized. The size of the parameter space and the time demand of training-testing iteration cycles corresponding to each parameter combination also pose a challenge.

For selecting the optimal values in the parameter space the so called “hyperparameter optimization” method may be applied (Bergstra, J. S., Bardenet, R., Bengio, Y., & Kégl, B. (2011). Algorithms for hyper-parameter optimization. In Advances in Neural Information Processing Systems (pp. 2546-2554)), which comprises the analysis of parameter ranges set up by the developers. In addition to the analysis of the complete parameter space, among others such algorithms can also be utilized (e.g. TPE—Tree-structured Parzen Estimator) which, based on the results of models yielded by the parameters analysed earlier, makes a decision on their own during optimization about which further parameter values are worth analysing. The parameter space can thus be narrowed down by the algorithms to domains deemed useful, reducing calculation time required for optimization. Utilizing hyperparameter optimization, accuracy can be improved by as much as 5-20%.

Smartphone manufacturers may build into the mobile devices sensors with different hardware specifications, moreover, the properties of the built-in sensors may differ even for the same phone model. Due to these differences, different values will be measured by the two devices when being subjected to totally identical accelerations, which may pose a challenge for solving problems based on acceleration values. Differences can be reduced applying normalization based on a common reference value. For establishing the reference value, the value of gravitational acceleration reported by the sensor is measured in a rest position of the device, and sensor data are then normalized based on that. Applying this solution accuracy can be improved by as much as 2-3% (all accuracy improvement values refer to cases wherein the accuracy of the generic model in not sufficient, i.e. there is room for improvement).

$${x}_{normalized} = \frac{{x}_{raw}}{{G}_{rest}}$$

The above formula gives an example for the normalization of the acceleration values measured along the X axis, where the reference gravitational acceleration measured in the rest position is denoted by Gᵣₑₛₜ, the current acceleration measured by the sensor is x_{raw}, and the normalized value is x_{normalized}. In this embodiment, therefore, the sensor data are acceleration data; these data are subjected to normalization. Accordingly, the data are normalized also in the acceleration patterns (training, measurement, and, optionally, personalization acceleration patterns).

It has been recognized that in the case of the targeted application the mobile device is in rest position for most of the time (e.g. when the user sleeps at night, the device is in a cloakroom etc.). When no significant change of the sensor data is detected (the data do not reach the threshold value, in rest position, depending also on the accuracy of sensor, e.g. values in the range of −0.15-0.15 m/s² can be measured) for a longer period of time (expediently, for more than 3 minutes), the sampling rate is reduced (preferably to 1 minutes). Thereby the energy consumption of the mobile device can be dramatically reduced. If a significant change is detected in sensor data, the standard sampling rate is restored.

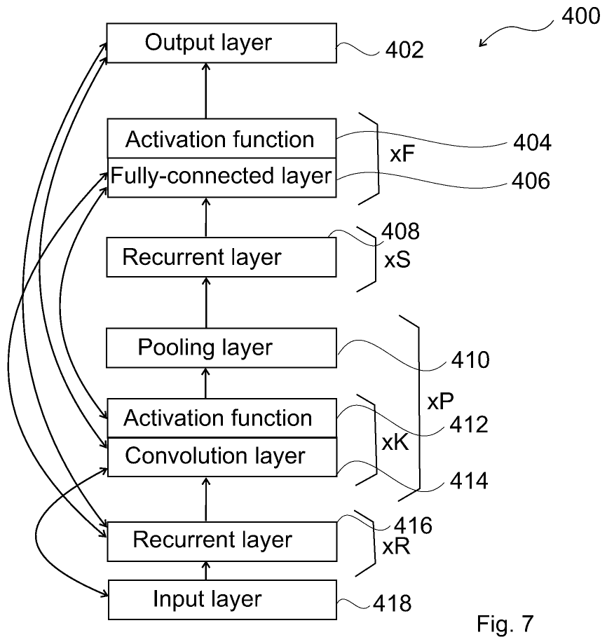

The system is preferably built on a client-server architecture (a pair of a client 420 and a server 425); the schematic structure of such an embodiment is shown in FIG. 9. The client 420 is implemented by a mobile device 430 (e.g. a smartphone) adapted for recording the sensor data and for transferring the recorded data to the server 425 either in “real time” or—without an active internet connection—after data recording has been completed.

In the case illustrated in FIG. 9, the “real time” processing of data received from the mobile device 430 and the classification of activities is performed by a TCP (transmission control protocol) server 434 (i.e. in this embodiment the functionalities of the decision unit are implemented on the server 425), while data uploads after completing data recording can be performed applying an FTP (file transfer protocol) server 436. The deep neural network-based models adapted for classifying the recorded data are generated by a modeling server 438 utilizing the data uploaded to the FTP server 436.

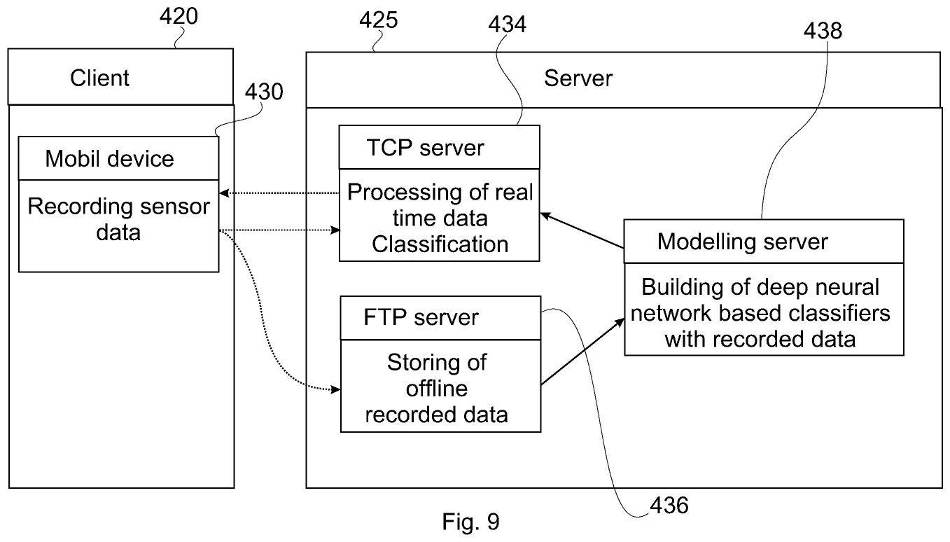

The client 420 implemented applying the mobile device 430 consists of three major components: a main application 440, a so-called widget 442 (small application), and background processes; the block diagram of the application is shown in FIG. 10. The minimum Android API (application programming interface) level of the application is preferably level 11, because the accurate adjustment of the sampling time of the sensors is supported by the system from this level up.

Utilizing the main application 440 running on the mobile device 430 the user can make the settings required for using the service. Data recording be started and stopped simply, utilizing a widget 442 added to the start screen. The widget 442 shows the categories of the activities that can be recorded. Data recording can be started by tapping on the desired category. Preferably, connection to the TCP server 434 can be enabled (via a TCP client 444) for “real time” data analysis. The mobile device 430 is connected to the FTP server 436 via an FTP upload service 446. In case the received data has been classified as a foot stamp (a preferred choice for the signal body gesture) by the gesture recognition models, a notice is given by the TCP server 434 to the client application that can perform the desired signaling steps. Signaling can be implemented as sending an SMS or email, as well as giving a confirmation signal by making a sound. The messages may include the user name specified on the phone sending the message, and—if available—the GPS coordinates of the smartphone (mobile device).

Acceleration sensors typically built into smartphones available today typically measure the forces on the device along three axes. FIG. 4 shows the positions of these axes relative to the phone (x: left-right, y: up-down, z: forward-rearward acceleration). In addition to that, the devices often comprise further sources of sensor data, for example: orientation sensor, light sensor, etc.

The user is preferably allowed to perform “real time” data recording (data transmission, processing, evaluation and sending back the results to the device all introduce a certain amount of delay, so it can be said that all of these activities are performed in approximately real time), in which case the application connects to the TCP server, and sends there the recorded sensor data utilizing the internet connection of the device. In such a case the activity category estimated by the models is likewise returned to the device via the TCP connection. During the recording the training data of the models it is not necessary (but preferable) to maintain an active internet connection (for the time of the recording), in which case the measurement results are saved to the internal storage of the phone, and can be later uploaded to the FTP server.

The server implements a continually running service that is adapted for continuously waiting for inbound connections from the clients, and is capable of simultaneously serving multiple clients. These services can be run on one or even multiple server machines. Expediently, the user is not in direct connection with the modeling server, communication therewith being performed by the TCP and FTP servers. A server configuration using, for example an Intel Core i7-4790 CPU, 32 GB of RAM and a Titan X 12 GB GDDR5 GPU can be applied.

The TCP server is adapted for “real time” processing of sensor data. The smartphone client application connects to the server using the internet connection of the device and communicates with it by means of TCP messages. The recorded sensor data are sent to the server by the smartphone, then the server processes the data and performs the steps required for the classification of the data. After completing the classification operation, the server sends back the results to the smartphone client through the already existing TCP connection. The decision unit applied according to the invention is therefore preferably implemented on the mobile device, however, there occur such situations wherein an optimal-accuracy model has such a high computational demand that it is not practical to run it on a mobile device. At the same time, it is preferable to implement the decision unit on the mobile device because this allows for issuing the alarm signal without an internet connection, and it also facilitates scalability (serving a large number of individual users at the same time). In such embodiments, therefore, wherein the decision unit is implemented on the mobile device, all of the required components of the system (kinetic sensor, decision unit) are implemented on the same device, i.e. a mobile device specially configured that way is in essence a device adapted for detecting a signal body gesture.

The FTP server is adapted for providing an interface through which the users can upload from their smartphones in a simple manner the data previously saved to the internal storage of their phone. Models adapted for gesture recognition are generated first and foremost by utilizing the data uploaded to this server.

The models perform the classification of the recorded data into categories, i.e. they decide on which activities were performed by the user during the recording of the data (basically deciding whether they can be classified into the signal body gesture category). The aim of modeling is preferably to enable the system to differentiate the sensor data corresponding e.g. to general activities (like walking, riding a car, etc.) from emergency signals made by foot stamping. The modeling server is adapted for training models based on deep neural networks utilizing the recorded data. Tasks related to the classification of “real time” data are performed by the TCP server utilizing the models generated by the modeling server.

In the field of artificial intelligence, deep neural networks are currently the most researched topic for a number of applications (Y. Bengio, “Learning deep architectures for AI.,” Foundations and trends in Machine Learning, pp. 1-47, 2009; A. Graves, A.-r. Mohamed and G. Hinton, “Speech Recognition with Deep Recurrent Neural Networks,” IEEE International Conference on Acoustics, Speech and Signal Processing (ICASSP), pp. 6645-6649, 2013). Research is fostered also by the development of technology, e.g. the progress made in the field of GPUs (graphical processing units) can be harnessed in this field for achieving significantly increased training speeds for models based on neural networks. Applying these developments allows for analysing problems that used to be infeasible to tackle in the past due to insufficient processing capacity. By increasing the number of hidden layers in deep neural networks, increasing-depth abstractions of the data become available, which allows for building more accurate models compared to conventional machine learning methods.

Neural networks are such systems adapted for modeling computational tasks that are capable of modeling complex non-linear relationships between the inputs of the network and the expected outputs. Neural networks are not only capable of solving a great number of tasks, but also proved to be better at these tasks than conventional algorithmic computational systems. Such tasks are, for example, various recognition problems, from as simple as recognizing printed numbers and characters to more complex ones, such as recognizing handwriting, images and other patterns (M. Altrichter, G. Horváth, B. Pataki, G. Strausz, G. Takács and J. Valyon, “Neurális hálózatok,” Panem, Budapest, 2006.). Another actively researched topic is automatic speech recognition (ASR), where neural network-based computational methods have replaced the traditionally most widely applied hidden Markov models (HMM; A. Graves, A.-r. Mohamed and G. Hinton, “Speech Recognition with Deep Recurrent Neural Networks,” IEEE International Conference on Acoustics, Speech and Signal Processing (ICASSP), pp. 6645-6649, 2013.).

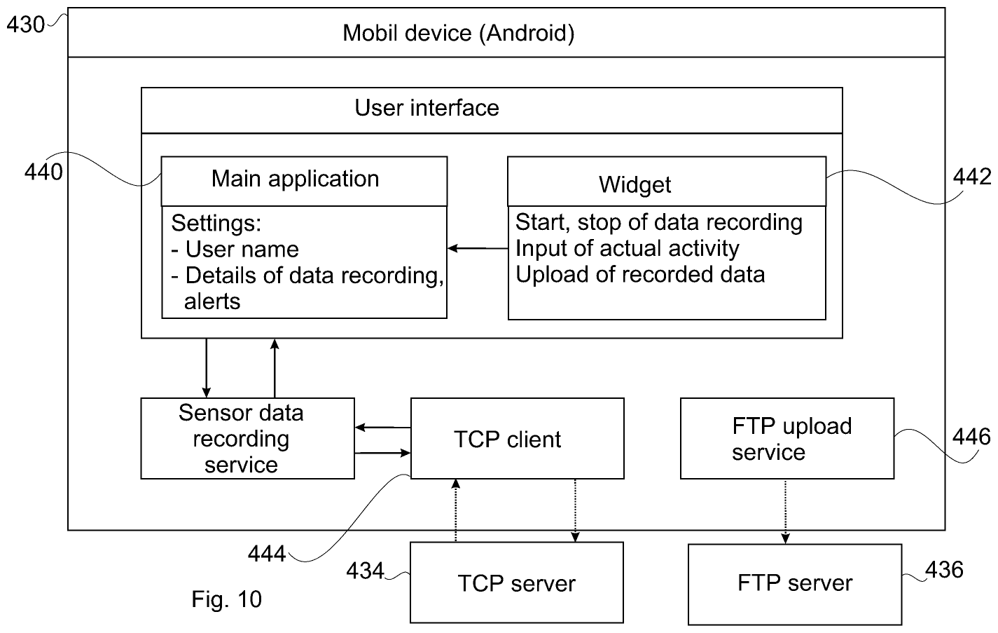

The smallest component of a neural network is the elementary neuron (FIG. 11), i.e. a processing element. The “classic” elementary neuron is a component with multiple inputs and a single output, realizing a non-linear mapping between the inputs and the output. An important characteristic of neural networks is that the non-linear activation function is called with the weighted sum of the inputs of the neurons. The function then returns the output value of the neuron. Training of the network involves modifying these weights in such a way that they result in the desired output value.

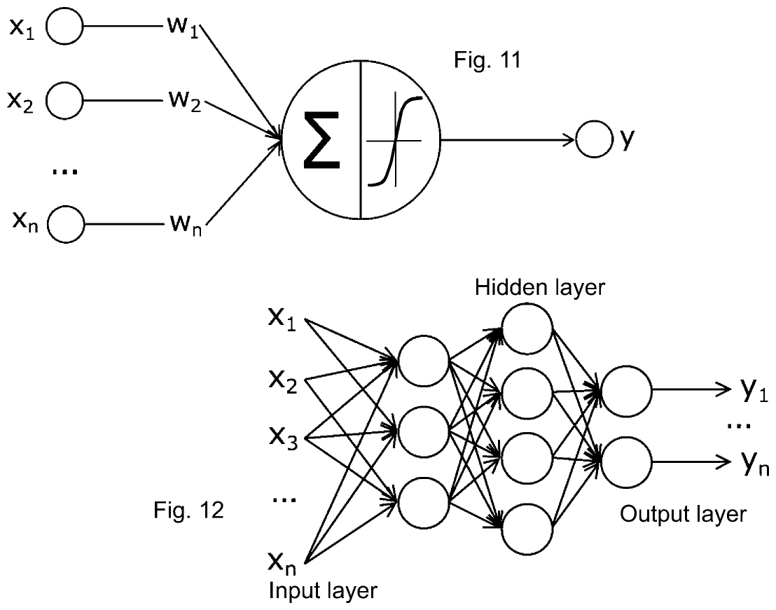

The topology of a neural network can also be represented by a directed graph. The neurons at the input constitute the input of the network, their output being adapted for driving the neurons at the deeper layers of the network. The purpose of the hidden layers is to transform the input signals into a form that corresponds to the output. An arbitrary number of hidden layers can be included between the input and output layer (see FIG. 12 showing a forward-connected neural network).

The data acquired from the sensors can be fed into architectures implementing multiple deep neural networks either without preprocessing, or after performing preprocessing (characteristic extraction), and thus the accuracy of signal body gesture (e.g. foot stamp) recognition can be improved applying different methods. This task is rather difficult because various different types of sensors are built into the different devices (and different devices have different sensor hardware even if the same sensor type is included). Due to potential calibration errors and measurement inaccuracies, sensors of the same type—e.g. accelerometers—but with different specifications can measure different values under identical conditions. In addition to that, the activities to be analysed also differ significantly from person to person, so large amounts of high-quality training data are required for building the models. Evaluation based on machine learning makes the processing of such diverse data much easier.

Users may unexpectedly find themselves in emergencies wherein they are either unable, or have no time to reach for their personal alarm device/smartphone (and unlock it) so that they can raise an alarm or initiate an emergency call. Therefore, there is a need for a device/method/application that can be applied for giving an alarm signal or making an emergency call even in such situations. This need is fulfilled by the system according to the invention.

As it can be established by analysing the prior art solutions, our method is advantageous since—in contrast to the above described, purely rule-based systems—a signal processing is applied via the machine learning classification algorithm (e.g. deep neural network), which allows that the mobile device need not be taken out from its storage place and handled in order to issue an alarm signal, and also no additional wearable devices are required. Therefore, thanks to the approach applied, it is not necessary to apply an external acceleration sensor. Furthermore, the approach is novel with respect to the activation gestures, because a given concrete number of foot stamps or indirect knocks of a given intensity are preferably utilized. Applying our adaptive sampling approach, the application saves the battery of the mobile device. A number of optimization approaches have been applied for providing the deep neural network that is applied exemplary in the machine learning classification algorithm. The invention can therefore preferably be applied with a mobile device that is “put away”, i.e. is carried inside the clothes or a storage device carried by the user.

The invention is, of course, not limited to the preferred embodiments described in details above, but further variants, modifications and developments are possible within the scope of protection determined by the claims.

1. A system for detecting a signal body gesture, comprising:
a mobile device including a decision unit and a kinetic sensor that records a measurement motion parameter pattern corresponding to a time dependence of a motion parameter of the mobile device in a measurement time window, wherein:
the decision unit applies a machine learning classification algorithm subjected to basic training by machine training with an application of a training database comprising one or more signal training motion parameter patterns each corresponding to at least one signal body gesture, and
in response to the measurement motion parameter pattern having a value equal to or exceeding a predetermined signal threshold value, classifying the measurement motion parameter pattern to a signal body gesture category.

2. The system according to claim 1, wherein:
the measurement time window is one of a plurality of measurement time windows,
the decision unit is adapted for assigning an occurrence probability that characterizes a probability of an occurrence of the signal body gesture, based on a measurement motion parameter pattern corresponding to a respective measurement time window, to each of the measurement time windows,
the classification of the measurement motion parameter pattern corresponding to a given time window to the signal body gesture category is decided by the decision unit based on a comparison of occurrence probabilities assigned to the given measurement time window and at least one previous measurement time window with probability threshold values assigned to the measurement time windows, and
the given measurement time window and the at least one previous measurement time window are subsequent to each other and at least a portion of the given measurement time window and the at least one previous time window overlap each other.

3. The system according to claim 2, wherein the occurrence probabilities assigned to the given measurement time window and to at least one previous measurement time window are arranged in descending series by the decision unit, and each of at least a part of the occurrence probabilities from the beginning of the series is compared with a probability threshold value corresponding to the position with gradually increasing serial number in the series, respectively.

4. The system according to claim 3, wherein the probability threshold values corresponding to positions with gradually increasing serial number are gradually smaller than or equal to the previous value.

5. The system according to claim 1, wherein, for classifying to the signal body gesture category, the values of the measurement motion parameter pattern, as well as short-term summation data and long-term summation data obtained at time instants of the measurement time window by summing up the values of the motion parameter or a power of the absolute values of the motion parameter over a short-term summation period, and a long-term summation period, respectively, are applied in the decision unit.

6. The system according to claim 5, wherein the length of the long-term summation period is 5-15 times the length of the short-term summation period.

7. The system according to claim 1, wherein in the decision unit components of the measurement motion parameter pattern are weighted according to relevance for classifying to the signal body gesture category.

8. The system according to claim 1, wherein the signal body gesture is a foot stamp or an indirect knock on the mobile device.

9. The system according to claim 1, wherein:
a start of each signal training motion parameter pattern corresponding to the signal body gesture of the training database applied for machine training is marked by pushing a button of an earphone set or headphone set of the mobile device recording the signal training motion parameter patterns, or by means of a recording sound signal, or
each signal training motion parameter pattern corresponding to the signal body gesture of the training database is recorded after a respective data entry request of the system.

10. The system according to claim 9, wherein an end of each signal training motion parameter pattern corresponding to the signal body gesture is also marked by pushing the button on the earphone set or the headphone set of the mobile device or by a recording sound signal.

11. The system according to claim 1, wherein the machine learning classification algorithm of the decision unit is subjected to the basic training by:
subjecting a machine learning classification algorithm of the decision unit to a basic training by a machine training that applies a training database comprising a plurality of signal training motion parameter patterns each corresponding to at least one of a plurality of signal body gestures.

12. A method for training a system including a mobile device having a decision unit to detect a signal body gesture, the method comprising:
subjecting a machine learning classification algorithm of the decision unit to a basic training by machine training that applies a training database comprising one or more signal training motion parameter patterns each corresponding to at least one of a plurality of signal body gestures.

13. The method according to claim 12, further comprising:
recording personalizing data from an end user, and
personalizing for the end user the machine learning classification algorithm of the decision unit based on the personalizing data.

14. The method according to claim 13, wherein the machine learning classification algorithm has respective group-level machine learning models corresponding to at least two user parameter groups formed according to user parameters, and the system further comprises an auxiliary decision unit having an auxiliary decision algorithm adapted for classifying the measurement motion parameter patterns into the at least two user parameter groups, and the method further comprises:
recording from the end user as personalizing data at least one personalizing motion parameter pattern corresponding to the signal body gesture; and
during the personalization of the machine learning classification algorithm of the decision unit for the end user:
the end user is classified to one of the at least two user parameter groups by the auxiliary decision unit based on the at least one personalizing motion parameter pattern, and
in the machine learning classification algorithm of the decision unit, the group-level machine learning model corresponding to the group according to the classification is applied.

15. The method according to claim 13, further comprising:
recording from the end user as personalizing data at least one personalizing motion parameter pattern corresponding to the signal body gesture; and
during the personalization of the machine learning classification algorithm of the decision unit for the end user, subjecting the machine learning classification algorithm having been subjected to the basic training to further training by machine training that applies the at least one personalizing motion parameter pattern.

16. The method according to claim 15, wherein the machine learning classification algorithm is a neural network-based algorithm, and the method further comprises, during the further training:
leaving weights of a neural network-based machine learning model corresponding to the machine learning classification algorithm subjected to basic training unchanged;
inserting complementary layers into the neural network-based machine learning model; and
applying the at least one personalizing motion parameter pattern for subjecting the complementary layers to further training by machine training.

17. The method according to claim 13, further comprising:
recording from the end user as personalizing data at least one personalizing motion parameter pattern corresponding to the signal body gesture; and
during the personalization of the machine learning classification algorithm of the decision unit for the end user:
leaving unchanged a machine learning model corresponding to the machine learning classification algorithm of the decision unit, and
subjecting the machine learning classification algorithm to the basic training by machine training utilizing the training database comprising the training motion parameter patterns as well as utilizing the at least one personalizing motion parameter pattern.

18. The method according to claim 17, further comprising:
taking into account, during the basic training, the at least one personalizing motion parameter pattern with larger weights compared to the training motion parameter patterns.

19. The method according to claim 13, further comprising:
recording from the end user as personalizing data at least one personalizing motion parameter pattern corresponding to the signal body gesture; and
during the personalization of the machine learning classification algorithm of the decision unit for the end user:
subjecting the machine learning classification algorithm to the basic training by machine training utilizing the training database comprising the training motion parameter patterns as well as utilizing the at least one personalizing motion parameter pattern, and
generating the machine learning model corresponding to the machine learning classification algorithm of the decision unit during the basic training.

20. The method according to claim 14, further comprising:
recording from the end user the at least one personalizing motion parameter pattern after a respective data entry request of the system.

21. The method according to claim 13, wherein the machine learning classification algorithm has respective group-level machine learning models corresponding to at least two user parameter groups formed according to user parameters, and the method further comprises:
recording from the end user as personalizing data a personal user parameter value of the user parameter characteristic of the end user;
classifying the end user, during the personalization of the machine learning classification algorithm of the decision unit for the end user, to one of the at least two user parameter groups based on the personal user parameter value; and
applying, in the machine learning classification algorithm of the decision unit, the group-level machine learning model corresponding to the group according to the classification.

22. A method for detecting a signal body gesture, comprising:
recording a measurement motion parameter pattern corresponding to a time dependence of a motion parameter of a mobile device in a measurement time window by a kinetic sensor;
applying a machine learning classification algorithm subjected to basic training by machine training with an application of a training database comprising one or more signal training motion parameter patterns each corresponding to the signal body gesture;
deciding on classifying the measurement motion parameter pattern to a signal body gesture category; and
in response to the measurement motion parameter pattern having a value equal to or exceeding a predetermined detection threshold value, detecting the signal body gesture.

23. A method for issuing an alarm signal, comprising:
recording a measurement motion parameter pattern by a kinetic sensor of a mobile device having a decision unit;
deciding, by the decision unit of the mobile device, on classifying the measurement motion parameter pattern into a signal body gesture category; and
if the measurement motion parameter pattern has been classified into the signal body gesture category by the decision unit, issuing the signal.

24. The method according to claim 23, wherein the signal controls an application on the mobile device.

25. The method according to claim 23 wherein the signal controls the mobile device.

26. A method for recording data, comprising:
marking starts of signal training motion parameter patterns corresponding to signal body gestures of a training database applied for machine training by pushing a button of an earphone set or headphone set of a mobile device recording the training motion parameter patterns or by a recording sound signal, or
recording each signal training motion parameter pattern corresponding to a signal body gesture of the training database after a respective data entry request of the system.

27. The method according to claim 26, further comprising:
marking an end of the signal training motion parameter patterns corresponding to the signal body gestures by pushing the button on the earphone set or headphone set of the mobile device or by means of a recording sound signal.
